(19) United States
(12) Patent Application Publication
(10) Pub. No.: US 2015/0142991 A1
(43) Pub. Date: May 21, 2015

(54) ELECTRONIC HUB APPLIANCES USED FOR COLLECTING, STORING, AND PROCESSING POTENTIALLY MASSIVE PERIODIC DATA STREAMS INDICATIVE OF REAL-TIME OR OTHER MEASURING PARAMETERS

(71) Applicant: Efficiency3 Corp., Falls Church, VA (US)

(72) Inventor: Joseph A. ZALOOM, Arlington, VA (US)

(21) Appl. No.: 14/592,813

(22) Filed: Jan. 8, 2015

Related U.S. Application Data
(63) Continuation-in-part of application No. 14/065,179, filed on Oct. 28, 2013, now abandoned.
Application No. 14/065,179 is a continuation-in-part of application No. 13/452,819, filed on Apr. 20, 2012, now Pat. No. 8,571,922.
(60) Provisional application No. 61/477,956, filed on Apr. 21, 2011.

(51) Int. Cl. H04L 29/08; H04L 12/26

(52) U.S. Cl. CPC H04L 67/1095; H04L 43/10
USPC 709/248

(57) ABSTRACT

This technology relates to an electronic hub appliance used for collecting, storing, and processing potentially massive periodic data streams indicative of real-time or other measuring parameters.

### CROSS-REFERENCE TO RELATED APPLICATIONS

This application is a continuation-in-part of U.S. patent application Ser. No. 14/065,179 filed Oct. 28, 2013; which is a continuation-in-part of U.S. patent application Ser. No. 13/452,819 filed Apr. 20, 2012, now U.S. Pat. No. 8,571,922 issued Oct. 29, 2013; which claims the benefit of U.S. Provisional Patent Application No. 61/477,956 filed Apr. 21, 2011. The disclosures of the prior applications are incorporated herein in their entirety by reference.

### STATEMENT REGARDING FEDERALLY SPONSORED RESEARCH OR DEVELOPMENT

None.

### FIELD

This technology relates to electronic hub appliances used for collecting, storing, and processing potentially massive periodic data streams indicative of real-time or other measuring parameters.

### BACKGROUND AND SUMMARY

Digital sensing has become pervasive and the market for smart appliances is growing rapidly and is projected to reach nearly $35 billion annually by 2020.

Some of these smart appliances and systems can generate massive streams of data and Short Message Service “SMS” notifications. Examples of such appliances that are currently on the market include small indoor and outdoor weather stations that measure and report indoor and outdoor temperatures and air quality by the second and send SMS messages when unhealthy temperatures and air quality occur, small video cameras that send continuous video streams of activities inside homes and offices and generate SMS messages when certain conditions occur, smart meters and sub-meters that have become so small and modular that they can measure the energy consumption of practically any system or appliance. All information from such devices and appliances commonly arrives in neat digital bundles called “packets” with associated time stamps and error correction information

These technological marvels provide useful but fragmented streams of data which are stored on different mediums and use different transmission means and protocols. Making sense out of this massive amount of information currently is a serious challenge—especially when it comes to comparing disparate streams of digital data that may uncover important uncommon correlations and insights.

### BRIEF DESCRIPTION OF DRAWINGS SHOWING EXAMPLE NON-LIMITING EMBODIMENTS

The following detailed description of exemplary non-limiting illustrative embodiments is to be read in conjunction with the drawings of which:

FIG. 1 illustrates a systems network diagram overview of how the proposed electronic appliance can serve as a hub that can collect streams of electronic data from several systems, appliances, and devices simultaneously and provide access to that information to various local computing devices as well as upload that information to a central database “in the cloud”.

FIG. 2 is a Component Diagram of the proposed example non-limiting electronic hub appliance and how it can collect and store continuous streams of electronic data, from various sources.

FIG. 3 illustrates a systems network diagram overview of how the proposed electronic appliance can serve as a hub that can collect streams of energy use data, weather data, and automated notifications from several systems, appliances, and devices simultaneously and provide access to that information to various local computing devices as well as upload that information to a central database “in the cloud”.

FIG. 4 is a Component Diagram of the proposed example non-limiting electronic appliance and how it can collect and store continuous streams of energy use data, temperature data, and automated notifications from outside sources.

FIG. 5 illustrates a non-limiting structural example of information and the structure of the information that may be collected by the proposed electronic appliance.

FIG. 6 is a detailed Structural Diagram of a new electronic appliance that instantly converts continuous streams of energy use data, weather data, and automated notifications by smart appliances and systems into meaningful information and actionable insights for the average energy user.

FIG. 7 illustrates a non-limiting Process Diagram of how the appliance may perform automated actions based on stored control protocols, rules, and thresholds.

FIG. 8 illustrates another non-limiting Process Diagram of how the appliance may perform automated actions related to safety and security based on stored control protocols, rules, and thresholds.

FIG. 9 shows an example non-limiting embodiment of an electronic appliance for enhancing the intelligent use of energy at residential, commercial, governmental, and industrial facilities.

FIG. 10 is a schematic of the various sections of the interactive touchscreen display panel of the proposed electronic appliance.

FIG. 11 illustrates an example non-limiting embodiment of the various elements of the interactive touchscreen display panel descripted in FIG. 10 above.

FIG. 12 illustrates how streams of metered energy data from a system, appliance, or device may be collected electronically and stored on the proposed appliance.

FIG. 13 illustrates how streams of automated Short Message Service “SMS” text notifications from smart systems, appliances, and devices may be collected electronically and stored on the proposed appliance.

FIG. 14 illustrates how streams of weather data from an outdoor weather station, or a web-based central database, may be collected electronically and stored on the proposed appliance.

FIG. 15 illustrates how metered energy, weather, and text data stored on the proposed electronic appliance may be dynamically fetched by the proposed appliance.

FIG. 16 illustrates the concept of how dynamically fetched metered energy data may be transferred from the appliance's storage medium into the appliance's Random Access Memory “RAM”.

FIG. 17 illustrates how dynamically fetched weather data may be transferred from the appliance's storage medium into the appliance's Random Access Memory “RAM”.

FIG. 18 illustrates how dynamically fetched energy and weather data which may be collected and stored in millisecond increments may be aggregated into seconds and minutes in the proposed appliance's RAM prior to being graphically displayed on the appliance's interactive touchscreen display panel.

FIG. 19 illustrates how the appliance's Central Processing Unit “CPU” and its Graphical Processing Unit “GPU” dynamically converts the digital energy use and weather information that was aggregated in the appliance's RAM into graphical displays on the appliance's interactive touchscreen display panel.

FIG. 20 illustrates how the appliance's CPU dynamically converts the digital energy use information that was aggregated in the appliance's RAM into tabular displays of energy use on the appliance's interactive touchscreen display panel.

FIG. 21 illustrates how the appliance's CPU dynamically converts the digital energy use information that was aggregated in the appliance's RAM and multiplied by a pricing template into tabular displays of energy costs on the appliance's interactive touchscreen display panel.

FIG. 22 illustrates how the appliance's CPU dynamically fetches the digital SMS notifications from the appliance's storage medium into RAM before displaying the information on the appliance's interactive touchscreen display panel.

FIG. 23 illustrates a non-limiting example of how the scrolling order of the information provided on the display panel of the proposed appliance may be rearranged based on a possible ranking parameter.

FIG. 24 illustrates another non-limiting example of how the scrolling order of the information provided on the display panel of the proposed appliance may be rearranged based on another possible ranking parameter.

FIG. 25 illustrates a non-limiting example overview of the type of settings that may be included in the proposed appliance's configuration screens.

FIG. 26 is a non-limiting illustration of an example non-limiting embodiment of how the interactive touchscreen display panel represents the requested comparative information in the context of a “Day” view—spanning 24 hours.

FIG. 27 is a non-limiting illustration of an example non-limiting embodiment of how the interactive touchscreen display panel represents the requested comparative information in the context of a “Zoomed-in” “Day” view—spanning 12 hours.

FIG. 28 is a non-limiting illustration of an example non-limiting embodiment of how the interactive touchscreen display panel represents the requested comparative information in the context of a “Week” view—spanning 7 days.

FIG. 29 is a non-limiting illustration of an example non-limiting embodiment of how the interactive touchscreen display panel represents the requested comparative information in the context of a “Month” view—spanning 42 days.

FIG. 30 is a non-limiting illustration of an example non-limiting embodiment of how the interactive touchscreen display panel represents the requested comparative information in the context of a “Year” view—spanning 12 months.

### DETAILED DESCRIPTION OF NON-LIMITING EXAMPLE EMBODIMENTS

The example non-limiting appliance that has been conceived and is disclosed herein consists of an electronic hub that can collect data from a dynamic combination of sensors from various devices that may use different means of communication and route them to a central location through different channels where the various streams of seemingly disparate data can be integrated, analyzed, and compared to one another to enable comparisons which may uncover uncommon correlations and insights and enable user-specified rules, thresholds, and protocols to take action across the various connected systems and appliances.

One example non-limiting application of the technology herein is to provide a system for enhancing the use and functionality of metered energy devices to enable users to dynamically isolate and visualize the level of success of individual energy management actions and the impact of unscheduled actions, events, and environmental factors over hourly, daily, weekly, and monthly time intervals against dynamically varying corresponding recent or historical baselines; to provide a commonly understood standard for measuring, predicting, prioritizing, and optimizing the operating efficiency of metered systems, appliances, and devices of various energy sources, as well as to diagnose and to document their operating efficiency.

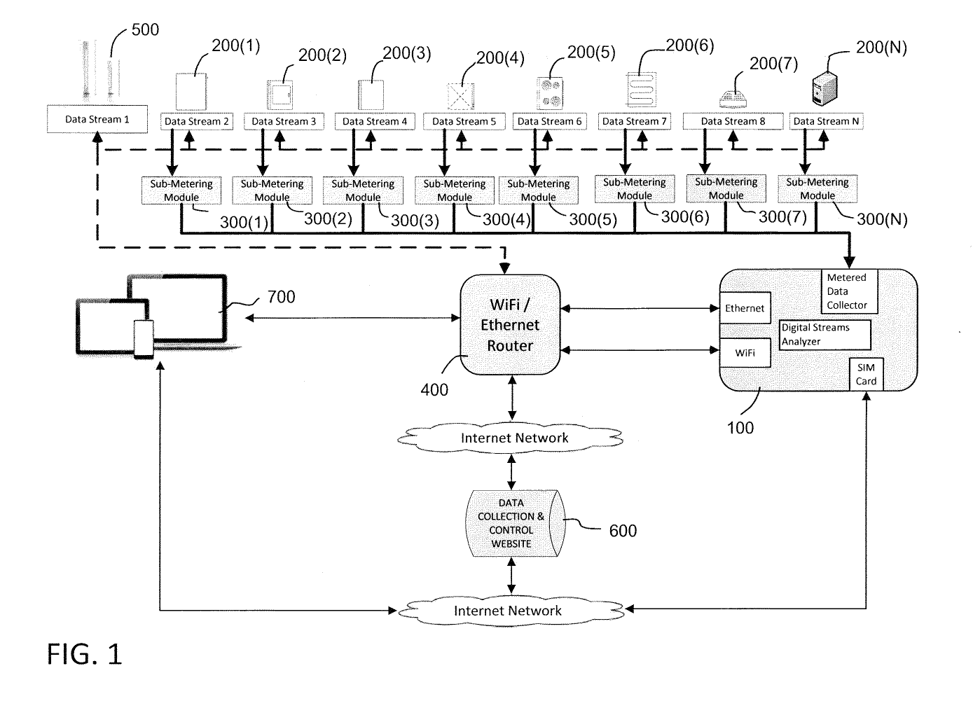

FIG. 1 shows a non-limiting example of a data stream analyzing system. Sources 200(1)-(200N) (any number) each produce a data stream. These data streams are measured and/or received by sub-metering modules 300(1) . . . 300(N). The sub-metering modules 300 provide their collected data streams to a stream analyzer 100. Stream analyzer 100 includes a metered data stream collector and a stream processor and analyzer. Stream analyzer in the non-limiting implementation is able to communicate wired or wirelessly, e.g., via Ethernet, WiFi, cellular telephone network, or any other desired or useful communications means. In the example shown, the stream analyzer 100 is linked both wired and wirelessly to a WiFi/Ethernet router 400 of the type that may be found in a home or business. The stream analyzer 100 also includes a SIM Card and associated communications interface that allows it to communicate with the cellular telephone network. The analyzer 100 may thus communicate via the Internet or any other network using these communications means for example to access a data collection and control website 600. The stream analyzer 100 may also communicate with a user interface 700 which may for example be a web-based or other user interface allowing users to input information and commands into the analyzer 100 and receive outputs in terms of displays or any other perceivable indicia.

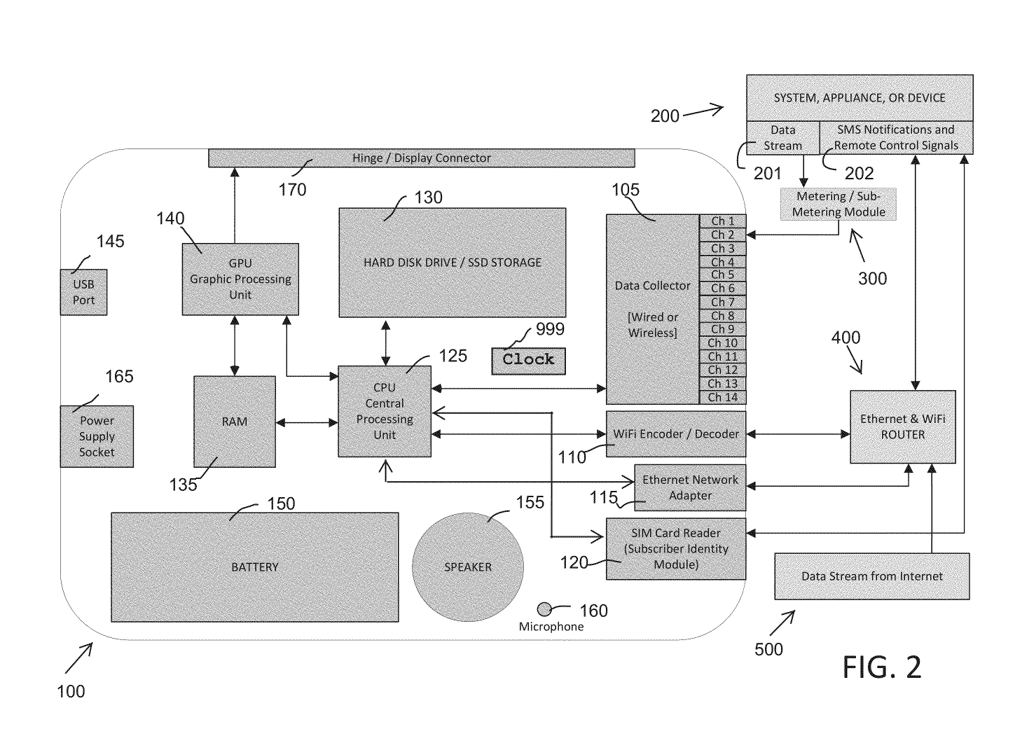

FIG. 2 is a block diagram of an example architecture for stream analyzer 100. In the example shown, stream analyzer 100 includes one or more central processing units 125 that execute software stored in non-transitory storage such as hard disc drive/SSD storage or a flash drive 130. CPU 125 is connected to random access memory 135 and also to a graphics processing unit (GPU) 140. CPU 125 is also coupled to various communications interfaces such as the WiFi encoder/decoder transceiver 110, an Ethernet network adapter 115, a SIM card reader and associated communications interface 120, and other communications mechanisms as desired. CPU 125 is able to generate audio outputs (either directly via an internal audio digital signal processor or using an external DSP) via a speaker 155 or other transducer. It is similarly also able to receive audio inputs via a microphone 160. CPU 125 also communicates via a USB port 145. Analyzer 100 is powered either via a battery 150 (e.g., for backup or portability) and via a conventional power supply 165.

In the example shown, analyzer 100 is also coupled to a multi-channel data stream collector 105. Data stream collector 105 may include any number of input channels that each receives an associated information data stream. These data streams can be received from any sources including for example the metering/sub-metering modules 300 described above, which in turn can be operatively coupled to various sources 200 that generate data streams.

Additional data streams 500 residing on the Internet can be accessed automatically by CPU 125 via the Ethernet and/or WiFi router 400 and the communications interface 110, 115, 120.

As can be seen in FIG. 2, the system appliance or device 200 which generates a data stream 201 may also include SMS notifications and remote control signals functionality allowing the CPU 125 to control aspects of the system, appliance or device. Such control can be provided for example in response to data streams the metering/sub-metering module receives.

### Example Non-Limiting Energy Usage Embodiment

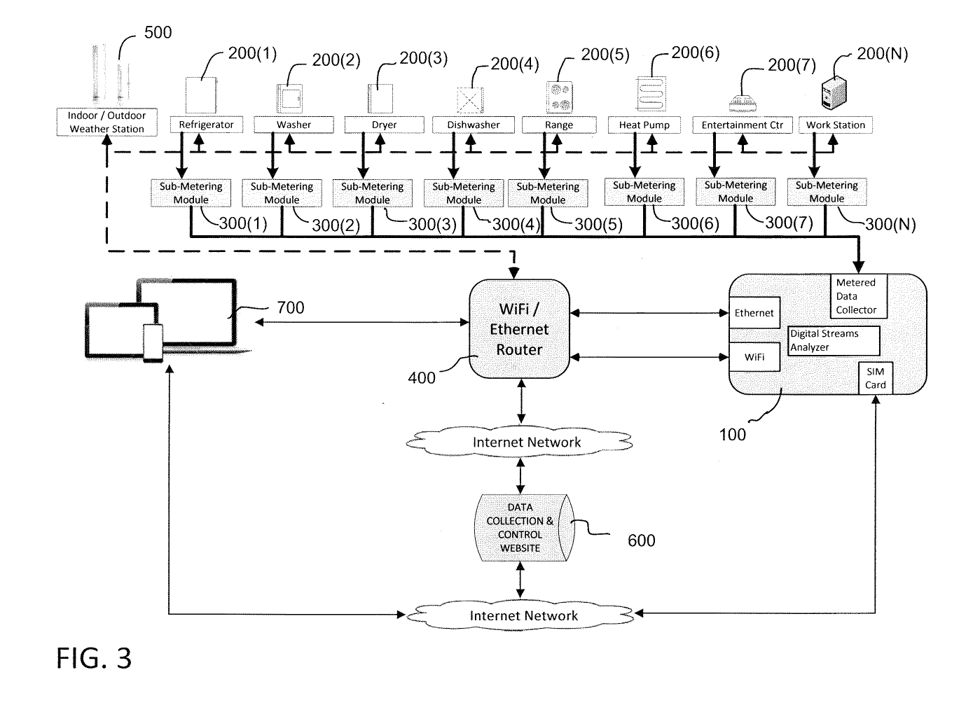

FIG. 3 shows one example non-limiting application of the architecture of FIGS. 1 and 2 for energy and other monitoring and control of household appliances.

The example non-limiting technology herein can provide a system for enhancing the intelligent use of energy, the system connected to (a) receive ongoing metered energy use data for any energy using device, system, or appliance in a home or facility/building, in time increments ranging from 1 millisecond to 1 hour or other time intervals; (b) program/schedule timed user-defined energy use actions; (c) receive and record unscheduled user-related energy use actions; (d) receive and record energy use related events (for example power failures, equipment failures, etc.); and (e) receive and store ongoing metered environment-related information such as indoor and outdoor temperatures and humidity.

At least one non-transitory storage device may store: (1) energy use metered data, (2) environmental data (metered temperature and humidity data), (3) automated systems and appliances generated electronic messages (SMS notifications) that include the timing of scheduled and unscheduled actions and events, (4) equipment operating schedules, (5) users log entries, (6) a learned insights database, (7) equipment specifications and operating parameters, (8) control protocols, (9) rules and thresholds, (10) energy pricing templates, (11) user statistics, (12) executable program.

At least one processor connected to the at least one storage device executes stored program code, the stored program code configuring the at least one processor to provide:

A Dynamic Periods Selector structure that dynamically selects a stream of real-time, recent, or historical energy use data of known operating parameters over time intervals that may encompass a day, week, month, or a year and a baseline period of known operating parameters, from the same stream of data (belonging to the same device, system, or appliance), that may encompass similar time intervals.

An Operating Profiles Synchronizer structure coupled to the Dynamic Periods Selector that dynamically fetches and synchronizes the energy data over the requested time intervals and sends the data to a coupled Energy and Weather Data Aggregator.

An Environmental Factors Synchronizer structure coupled to the Dynamic Periods Selector that synchronizes the start time of real-time or recent weather data with similar historical weather data as specified by the Dynamic Periods Selector by day, week, month, or year and sends the data to a coupled Energy and Weather Data Aggregator.

An Energy and Weather Data Aggregator structure coupled to the Operating Profiles Synchronizer and the Environmental Factors Synchronizer that aggregates the synchronized operating profiles data and environmental factors data in increments ranging from 1 second to 1 hour over the requested time interval (e.g., day, week, month, or year).

A Net Effect Visualizer structure coupled to the Energy and Weather Data Aggregator that visualizes the level of success of scheduled actions and the impact of unscheduled actions, events, and environmental factors by visually superimposing the data synchronized by the Operating Profiles Synchronizer and aggregated by the Aggregator in order to give shape, magnitude, and direction to the net effect of a change in operating profile between a selected period and a corresponding baseline “Net Effect”. The Net Effect Visualizer structure also overlays corresponding environmental factors when such factors influence a device or system's operating profile.

A Net Effect Tabulator coupled to the Net Effect Visualizer structure tabulates the Net Effect of the change in operating profile by subtracting or otherwise differencing or correlating the baseline operating profile data from the real-time or recent operating profile data over the selected time intervals in the specified time increments and places the resulting table directly under the Net Effect Visualizer graphs in order to visually connect (or correlate) the shape, magnitude and direction of the Net Effect of changes in energy operations with their corresponding numeric data.

A Net Effect Analyzer structure coupled to the Net Effect Tabulator structure analyzes the Net Effect of the change in operating profile against threshold limits and defined rules for real-time and historic fault detection and compares with stored information to form a diagnosis. The Net Effect Analyzer structure also analyzes the Net Effect of the change in operating profile for real-time initiation of automated processes when certain conditions between real-time and baseline factors are met.

A Net Effect Value Assessor structure coupled to the Net Effect Tabulator structure applies pricing templates to numerically assign and tabulate value assessments (e.g., cost, money units, efficiency, etc.) to the Net Effect of the change in operating profiles in specific time increments as derived in the Net Effect Tabulator in order to provide a commonly understood standard for measuring, understanding, and predicting the level of success of implemented energy management actions and placing the resulting table also directly under the Net Effect Visualizer graphs in order to visually connect (or correlate) the shape, magnitude and direction of the Net Effect of changes in operations to their corresponding changes in costs.

A Diagnostics Center structure coupled to the Dynamic Periods Selector structure dynamically fetches and synchronizes automated systems and appliances generated notifications as well as user generated manual log entries over the requested time intervals and places the resulting table next to the Net Effect Visualizer graphs so that one can quickly diagnose with fidelity and precision the Level of Success of the scheduled energy use actions and events during the period of time that is being analyzed as well as the impact of the unscheduled energy use actions and events that occurred during that same period of time.

A Systems Rankings Generator/Prioritizer structure coupled to the Net Effect Value Assessor structure ranks and sorts the order of displayed devices or systems from various energy sources by sorting and stacking the visual graphs and associated tables for each device vertically by cost (as a common denominator) in a computing device, in order to prioritize corrective and energy optimization measures/actions.

The example non-limiting system is able to dynamically measure the level of success of a change in a scheduled activity or the impact of an unscheduled activity, energy related event, or environmental factor against multiple (dynamically selected) baselines by dynamically selecting a stream of metered real-time, recent, or historical energy use data over time intervals that may encompass a day, a week, a month, or a year and a baseline period. The baseline period may encompass similar time intervals from the same stream of metered data belonging to the same device, system, or appliance)

This allows the example non-limiting system to serve multiple purposes:

The type of baseline can determine whether a user can measure the level of success of a particular energy management action, or determine the presence of “faults” (equipment failures). If the selected baseline is representative of an “average” or “optimum” energy use for a system (e.g., a heating system), then the comparison can detect “faults” or problems if energy use deviates substantially from the desired average or optimum energy use; if on the other hand, the baseline is representative of an “initial state” of known operating parameters, then the comparison will show the “level of success” of the action taken with respect to that initial state.

Sometimes a user may want to compare the level of success of a particular action to a prior day (incremental change), or to a specific date (differential change). Comparison to a specific date (differential change) may be important, for example, when one wants to compare the level of current energy consumption of a metered system to a specific date when a major change of that system occurred (e.g., to the date that a user had effected a major change in the heating system). On the other hand, an incremental change may be useful when a user changes the operating hours or the operating parameters of a system from one day to the next (e.g., longer operating hours, lower indoor temperature, etc.).

“Dynamic periods selection” may be for example in the context of the same stream of data (comparing a system, appliance, or device to itself). One could also use dynamic periods selection to compare a stream of energy data from one system, appliance, or device to a stream of energy data from another device, system, or appliance.

The system's method for visually isolating specific actions and events may visualize actions and events that may span minutes or hours in the context of a day view, and then enable the user to “zero-in” on the specific minutes and hours by zooming in on the section of the day view that is of relevance to the user; by visualizing actions and events that may span days in the context of a week view, and then enabling the user to “zero-in” on the specific day and hours by zooming in on the section of the week view that is of relevance to the user. One may visualize actions and events that may span days or weeks in the context of a month view, and then enable the user to “zero-in” on the specific day or week by zooming in on the section of the month view that is of relevance to the user.

The system can instantly visualize the level of success of scheduled actions and the impact of unscheduled actions, events, and environmental factors by visually superimposing the data synchronized by the Operating Profiles Synchronizer and aggregated by the Aggregator. This can give shape, magnitude, and direction to the net effect of a change in operating profile between a selected period and a corresponding baseline, as well as overlay corresponding environmental factors when such factors influence a device or system's operating profile in order to visually determine the correlation between changes in environmental factors and corresponding changes in operating profiles.

The system can “zero in” and pinpoint the net energy use effect of a specific energy related action or event on a device, system, or appliance's operating profile by dynamically correlating and visualizing the relationship between the graphical representation of the net effect of a change in operating profile “Net Effect” and its corresponding numerical representation. This can be done by locating the Net Effect Tabulator's tabulated numeric data directly below the superimposed energy usage graphs generated by the Net Effect Visualizer and synchronizing any changes in the graphical representation with changes in the tabulated numeric representation.

The system can dynamically re-set control protocols, including rules and thresholds, by linking them to percentage changes in the Net Effect of changes in operating profile between real-time and baseline factors (as opposed to being based on fixed energy use and environmental parameters). When a different baseline is dynamically selected, that results in a different Net Effect, the control protocols, rules, and thresholds are dynamically changed. This is useful for example when different baselines are selected for summer operations versus winter operations for a particular system, home, facility, or appliance.

The system's method of “zeroing in” and pinpointing the net value effect of a specific energy management action or event on a device, system, or appliance's operating profile by dynamically correlating and visualizing the relationship between the graphical representation of the net effect of a change in operating profile “Net Effect” and its corresponding representation by locating the Net Effect Value Assessor's data directly below the superimposed energy usage graphs generated by the Net Effect Visualizer and synchronizing any changes in the graphical representation with changes in the tabulated financial representation.

Using the system's Net Effect Value Assessor can keep operating budgets under control by setting up automated control protocols, rules and thresholds based on up-to-date operating costs versus budgeted costs for individual systems and appliances or a home or facility overall.

The system can form a diagnosis by selecting time-stamped automated notifications sent by the specific smart system or appliance as well as manual log entries related to the same system or appliance for the period that corresponds to the time period over which the Net Effect is being visualized and placing them right next to the Net Effect graph that is being analyzed (or otherwise analyze them in parallel or together) so that one can quickly diagnose with fidelity and precision the level of success of the scheduled energy use actions and events during the period of time that is being analyzed as well as the impact of the unscheduled energy use actions and events that occurred during that same time period.

The system can rank and prioritize corrective measures and energy optimization measures of system powered by different energy sources by using the Net Effect Value Assessor to apply pricing templates to numerically assign and tabulate monetary values to the Net Effect of the change in operating profile in order to provide a universal and commonly understood standard for measuring and ranking the level of success of implemented energy management actions as well as the impact of unscheduled actions, events, and environmental factors on systems, devices, and appliances powered by different energy sources. Systems Rankings Generator/Prioritizer can be used to sort and stack the visual graphs and associated tables for each device vertically by cost (as the common denominator) in a computing device in order to prioritize corrective and energy optimization measures/actions.

The electronic hub can collect data from a dynamic combination of sensors from various devices that may use different means of communication and route them to a central location through different channels where the various streams of seemingly disparate data can be integrated and compared to one another to enable comparisons which may uncover uncommon correlations and insights and enable user-specified rules, thresholds. Protocols can be implemented to take action across the various connected systems and appliances.

In the example shown in FIG. 3, the stream sources may comprise household appliances such as a refrigerator 200(1), a washing machine 200(2), a dryer 200(3), a dishwasher 200(4), a range 200(5), a heat pump 200(6), an entertainment system 200(7), a work station 200(8), or any variety of other devices and appliances commonly found in a residential environment including smartphones, tablets, telephone or other digital communications units, environmental monitoring units such as indoor and/or outdoor weather stations 500, light sensors, electronic thermostats, smart televisions, home security systems, imaging systems such as cameras, sound monitoring systems such as microphones, vibration monitoring systems, strain and/or pressure gauges or sensors, or any other source(s) of analog and/or digital signals that provide continual, periodic, intermittent, utility power meter, or any other streams of information.

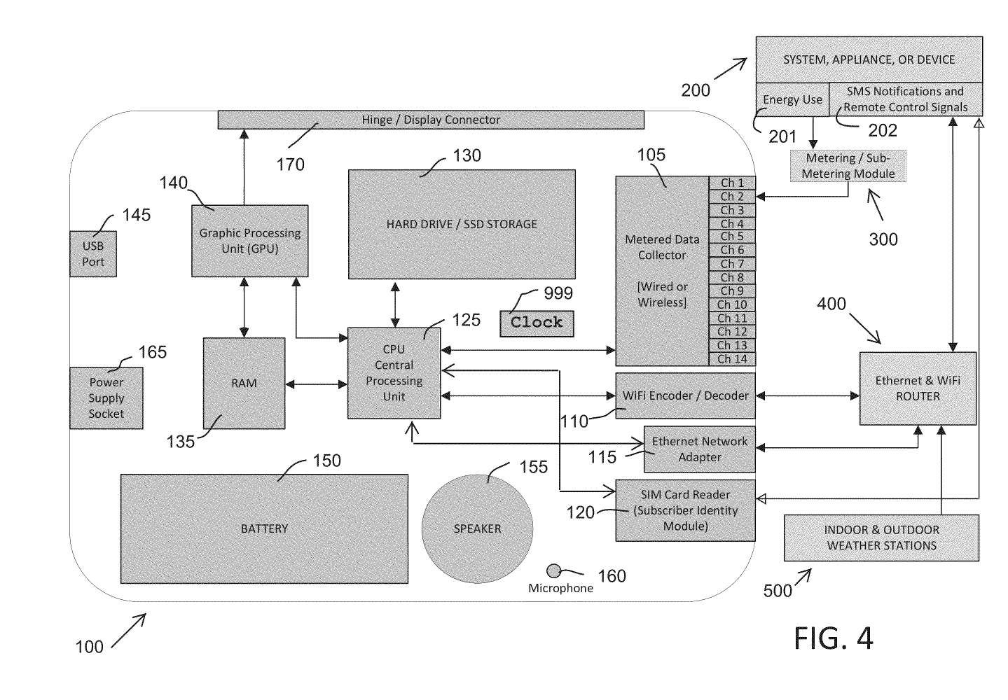

FIG. 4 repeats the architectural structure of FIG. 2. In the example shown, the data streams 201 that are being collected relate among other things to energy usage of the various stream sources 200 and the system is also connected to gather environmental information from indoor/outdoor weather stations 500 as some of the streams being collected.

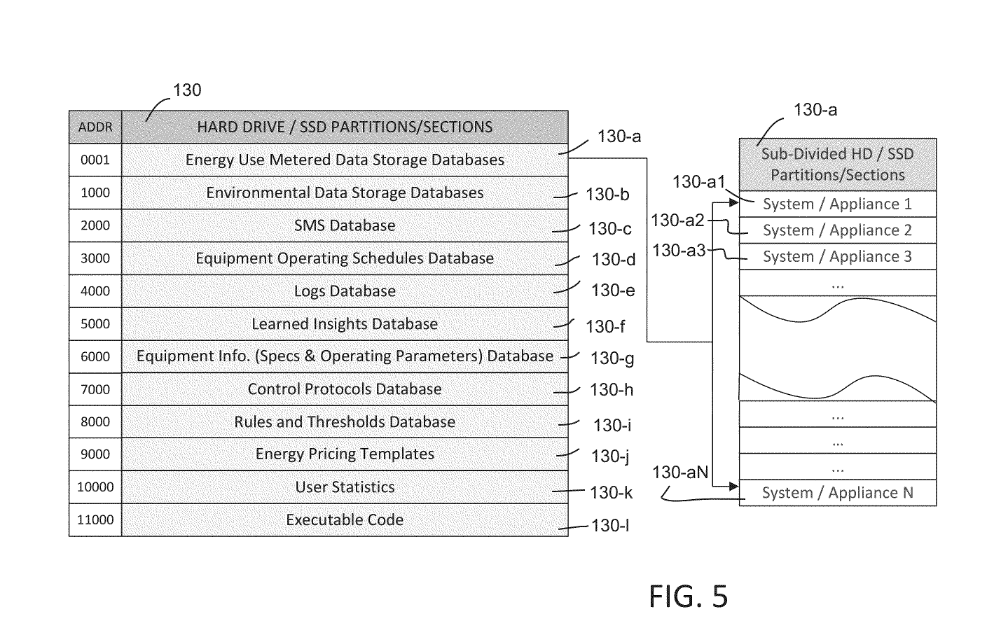

FIG. 5 shows an example database stored by the analyzer 100 within the non-transitory device 130. This example database includes for example energy use metered data storage databases 130-a, environmental database storage databases 130-b, SMS database 130-c, equipment operating schedules database 130-d, logs database 130-e, learned insights 130-f, equipment information (specs and operating parameters) database 130-g, control protocols database 130-h, rules and thresholds database 130-i, energy pricing templates 130-j, user statistics 130-k, and executable code 130-1. CPU 125 executes the executable code 130-1 in order to manipulate and maintain the various other databases 130. In this example shown, additional storage areas within non-transitory storage 130 are allocated to store the data streams being collected by the metered data collector 105. Thus for example, a first storage area 130-a1 is allocated to systems/appliances data stream, a further data storage 130-a2 is allocated to the data stream collected from a system/appliance 2, and so on. Any number of data streams can be collected and stored in the non-transitory storage 130 depending upon application and use.

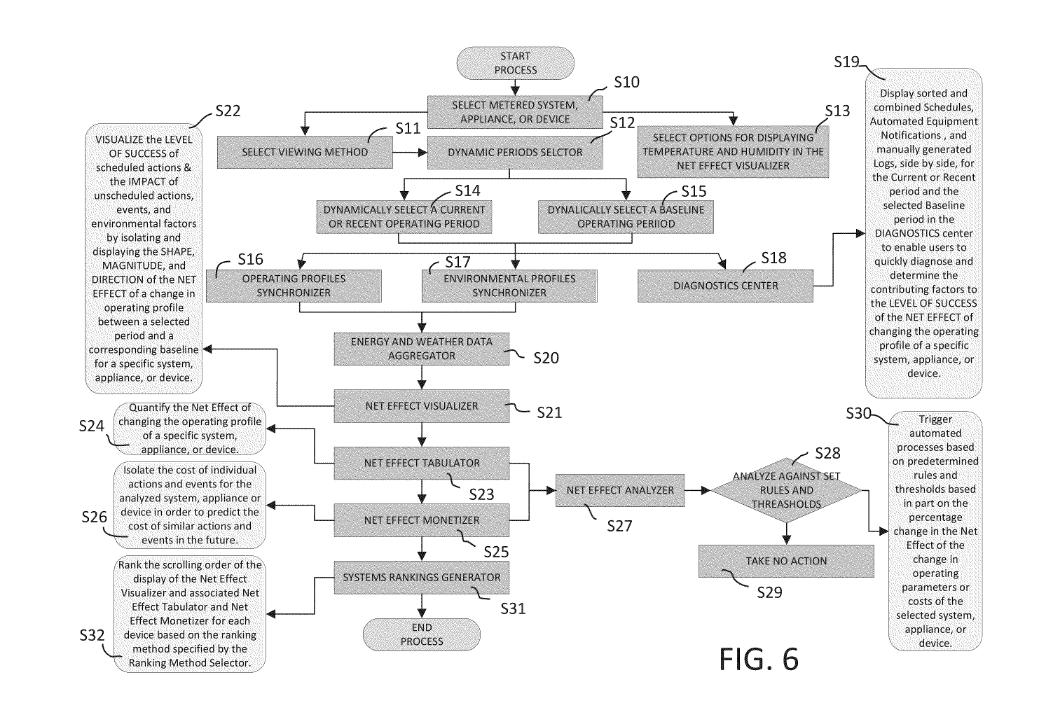

FIG. 6 is an example non-limiting software structure diagram that shows an example non-limiting structure for the executable code 130-1 stored by non-transitory storage 130. As shown, a select metered system, appliance or device S10 multiplexer within the executable code permits a user to select a viewing method S11 and/or select options for displaying temperature and humidity in a net effect visualizer S13. Meanwhile a dynamic periods selector S12 allows selection by the software automatically and/or based upon user input to select dynamic periods for data stream analysis. This dynamic periods selector S12 in one example non-limiting embodiment permits and enables CPU 125 to select subsets of one, two or more data streams based on time information encoded in the streams. Some data streams, for example, may include explicit time stamps for each data entry or packet contained in the stream that indicates some time parameter such as when the data or packet was acquired. Other data streams may include implicit timing information. As an example, some data streams may include captured periodic information, so that CPU 125 is able to infer that in a sequence of captured data, each data packet was captured at a certain time relative to the rest of the data packets in the stream. In other example implementations, the CPU 125 in conjunction with the data collector 105 may in real time acquire data streams and supply time clock 999 and/or time stamping or other explicit and/or implicit timing information into the databases shown in FIG. 5 so that the data streams respective of their time and coding as inputted to the FIG. 1 system nevertheless have timing information associated with each or at least some of the packets in the stream.

Referring again to FIG. 6, the dynamic periods selector structure S12 dynamically selects a current or recent operating period S14 in one exemplary non-limiting implementation, and also dynamically selects a baseline operating period S15 of the same or different stream. The executing software may then further include an environmental profiles synchronizer S17, an operating profiles synchronizer S16 and other synchronization structures that permit CPU 125 to synchronize different portions of the same or different acquired streams for comparison, analysis, correlation, cost-correlation, differencing, summing or other combinatorial analysis. In one example non-limiting implementation, an energy and weather data aggregator S20 can, for the particular application of assessing energy usage, aggregate a weather data stream with one or more energy usage indicative data streams in order to provide a combinatorial functionality that assesses for example current, recent or other usage as compared to prior (e.g., baseline) usage with correlation to environmental or weather conditions such as weather, temperature, air quality, or any other additional parameter.

A net effect visualizer S21 may then provide, in the form of additional software structure, functionality that allows CPU 125 to cooperate with GPU 140 to generate displays or presentations on screens, either locally or remotely, or by other means in order to visualize the level of success of unscheduled actions, events, environmental factors, or other factors, by isolating and displaying the shape, magnitude and/or direction of the net effect of the change in operating profile between a selected period and a corresponding baseline for a specific system, appliance, or device or for a combination of systems, appliances and/or devices.

The executing software may further include a net effect tabulator S23 that can be used to quantify the net effect of changing and operating profile of a specific system, appliance or device and/or combinations thereof. A net effect valuator or monetizer values, by money or other financial measures, efficiency, statistics or any other valuation, either normalized or un-normalized, to for example isolate the cost or value of individual actions and events for the analyzed system, appliance and/or device in order to predict the cost of similar actions and events in the future or to understand the consequences of past actions or events.

The executing software further includes a systems ranking generator S13 that may rank for example the order (e.g., based on scrolling) of the display of the net effect visualizer and associated net effect tabulator and net effect monetizer for each device based on the ranking methods specified by a ranking method selector—which can be based on user input, automatic decision making, previously-specified parameters or any combination thereof.

A net effect analyzer structure S27 may analyze results described above against set rules and thresholds to decide whether to take no action or to positively change or implement changes in the operating environment—automatically or by instructing users. As one example, it is possible for the net effect analyzer to automatically trigger, based upon remote control or other protocols, automated processes based on predetermined rules and thresholds based upon percentage change and the net effect of the change in the operating parameters and/or the costs of the selected system, appliance or device or combinations thereof.

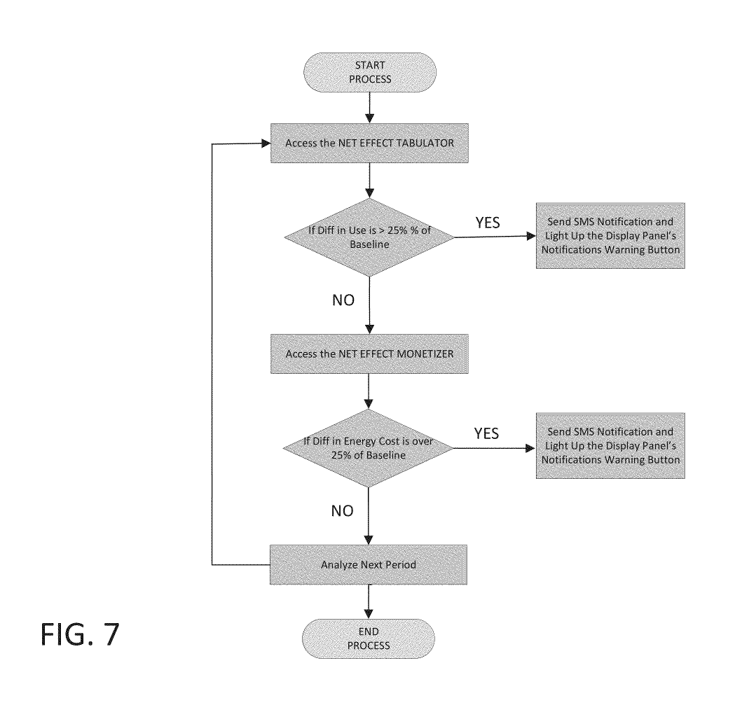

FIG. 7 shows an example non-limiting process for providing such automatic triggering and/or notifications as described in block S30. In the example shown, a software executing process may access the net effect tabulator structure S23 and then determine whether a difference in use is greater than a threshold (e.g., 25% of the baseline). If the difference in use is in excess of 25% (or any other desired threshold) of baseline, the CPU 125 can, through its communications interfaces 110, 115, 120 send an SMS notification or other messaging command or notification to a corresponding device or system or component, and may also display on a display panel, a notifications warning button. Similarly, if the FIG. 7 example non-limiting functionality upon accessing the net effect monetizer S25 determines that the value accessed by the valuator function is in excess of a threshold such as 25% over a baseline, a similar notification (SMS or other) can be transmitted and a warning displayed. Such processing can be entered over any number of different time periods to provide appropriate warnings and/or control functions.

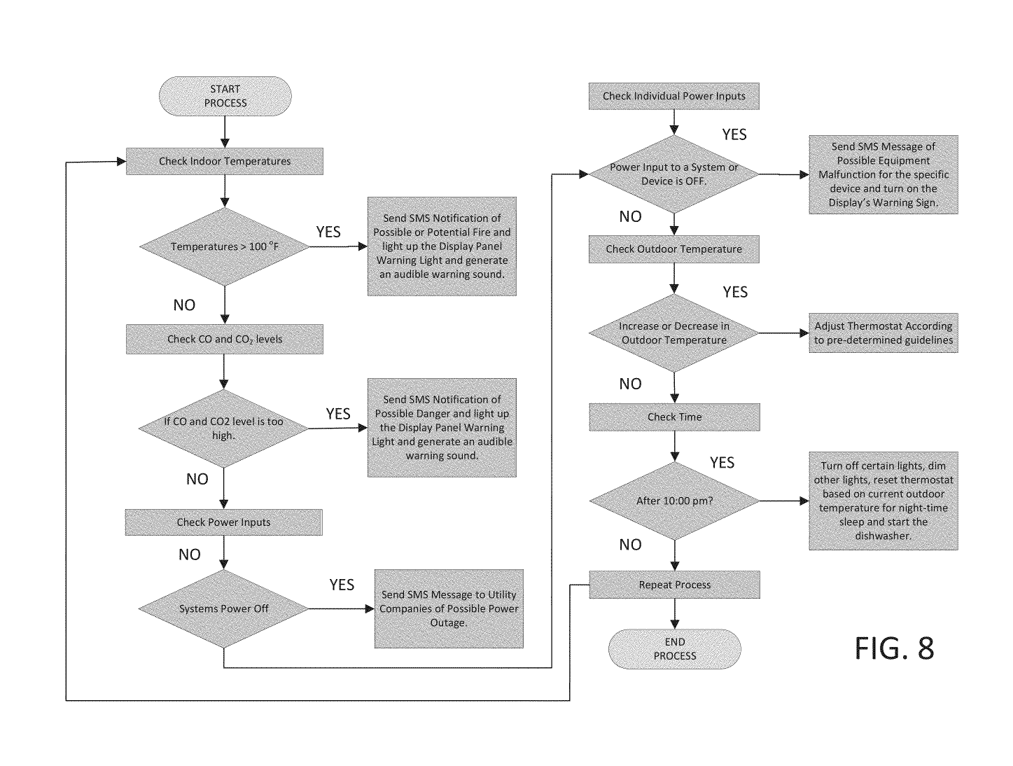

FIG. 8 shows an example non-limiting environmental process that takes into account a data stream indicative of environmental conditions such as temperature. In the example of FIG. 8, CPU 125 may check indoor temperatures by monitoring a temperature data stream provided by a thermostat, temperature sensor, thermo couple, thermistor or any other desired sensor, and determine whether the temperatures being monitored exceed a threshold such as 100° F. If the monitored temperatures are in excess of the threshold, CPU 125 can send a notification as described above indicating for example a possible potential fire and using its speaker 155 and/or external transducing devices, generate an audible warning and/or a visible warning. CPU 125 may further monitor data stream outputs of a carbon monoxide sensor of conventional design to check whether carbon monoxide and/or carbon dioxide levels are too high. If CPU 125 through monitoring of such data streams determines that the CO and/or CO₂ levels are in excess of predetermined thresholds, the CPU 125 may similarly generate audible and/or visible warnings. CPU 125 may further monitor a data stream indicating power input states to determine whether the main system power is on or off. If the CPU 125 determines that the power is off, it may send a message to appropriate destinations (e.g., a user smart phone, a utility company, etc.) indicative of possible power outages. CPU 125 may also check individual power inputs to determine whether power inputs to individual monitored data stream sources is unavailable or down and if so, generate appropriate message indicating possible system malfunction of a specified device. CPU 125 may use an outdoor weather station 500 or other outdoor sensing and/or monitoring components to check outdoor temperature and may respond to such temperature data streams by adjusting control parameters to for example control a heat pump 200(6) and/or other temperature regulation components according to predetermined guidelines. CPU 125 may also poll or query a real time clock 999 to determine whether the current time is after 10 PM or any other predetermined or desired time, and if so, adjust or control certain data stream source functionality such as for example turning off certain lights, dimming other lights, resetting thermostats based on current outdoor temperature for nighttime sleep, starting a dishwasher, or any other “smart home” functionality. Such control interfaces and functionality may allow CPU 125 to interact directly with an associated system, appliance and/or device including a processor and input control parameter or may use conventional power switching and/or other remote control functionality such as carrier communications as is well known in the art. The FIG. 8 process may be inventive, repeating continually to provide continual monitoring and control of a variety of different systems and functions based on need.

Returning to FIG. 6, the executing software may further include a diagnostics center S18 that for example may display assorted and combined schedules, automated equipment notifications and manually generated logs, side by side, for the current or recent period and the selected baseline period in a diagnostics center to enable a user to quickly diagnose and determine contributing factors to the levels of success of the net effect of changing the operating profile of a specific system, appliance or device or combinations thereof. Such a diagnostics center may provide automatic and/or manual control opportunities to solve problems.

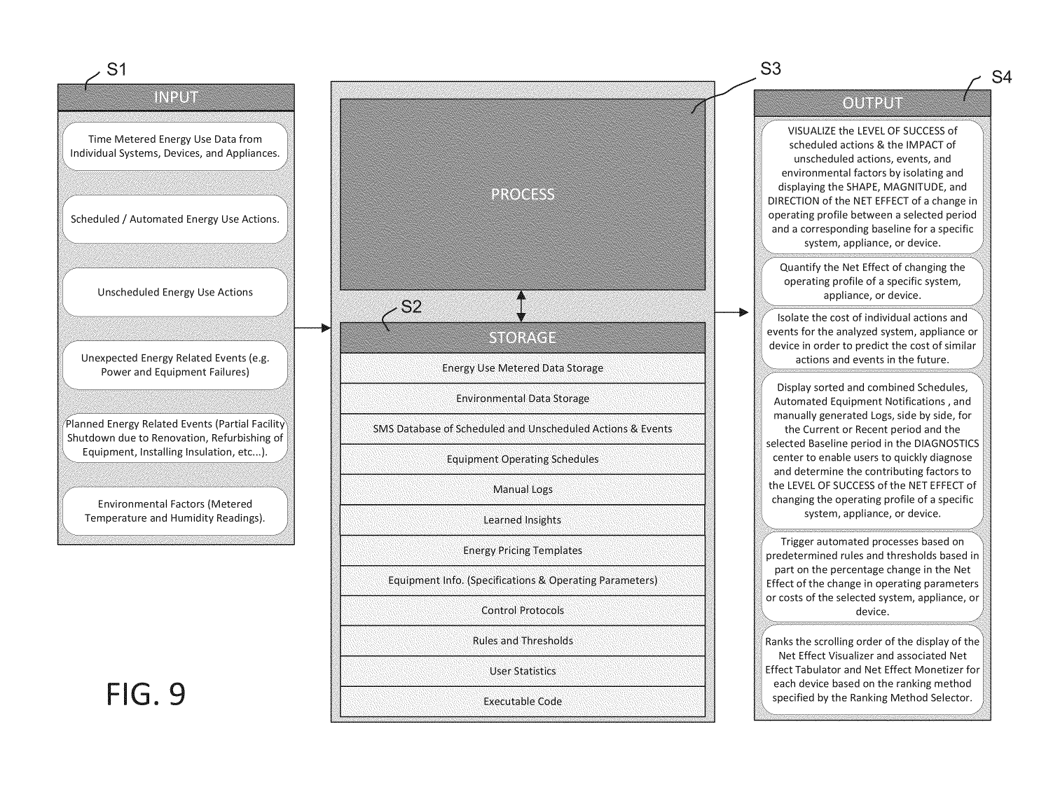

FIG. 9 shows an example additional view of the overall system software structure including input functionality, processing functionality, and output functionality. Input functionality S1 may include but not be limited to:
time metered energy use data from individual systems, devices and appliances
scheduled/automated energy use actions
unscheduled energy use actions
unexpected energy related events (e.g., power and equipment failure)
planned energy related events (partial facility shutdown due to renovation, refurbishing of equipment, installing insulation, etc.)
environmental factors (metered temperature and humidity readings)

In the FIG. 9 processing block S2, the software structure stored in the non-transitory storage device 30 may include:
energy metered data storage
environmental data storage
SMS database of scheduled and unscheduled actions and events
equipment operating schedules
manual logs
learned insights
energy valuation and/or pricing templates
equipment information (specifications and operating parameters)
control protocols
rules and thresholds
user statistics
additional executable code

As further shown in FIG. 9, output functionality S4 executed by CPU 125 may include:
visualize the level of success of scheduled actions and the impact of unscheduled actions, events and environmental factors by isolating and displaying the shape, magnitude, and direction of the net effect of a change in operating profile between a selected period and a corresponding baseline for a specific system, appliance or device
quantify the net effect of changing the operating profile of a specific system, appliance or device
isolate the cost of individual actions and events for the analyzed system, appliance or device in order to predict the cost of similar actions and events in the future
display sorted and combined schedules, automated equipment notifications, and manually generated logs, side by side, for the current or recent period and the selected baseline period in the diagnostics center to enable users to quickly diagnose and determine the contributing factors to the level of success of the net effect of changing the operating profile of a specific system, appliance of device
trigger automated processes based on predetermined rules and thresholds based in part on the percentage change in the net effect of the change in operating parameters or costs of the selected system, appliance or device
rank the scrolling order of the display of the net effect visualizer and associated net effect tabulator and net effect monetizer (valuator) for each device based on the ranking method specified by the ranking method selector

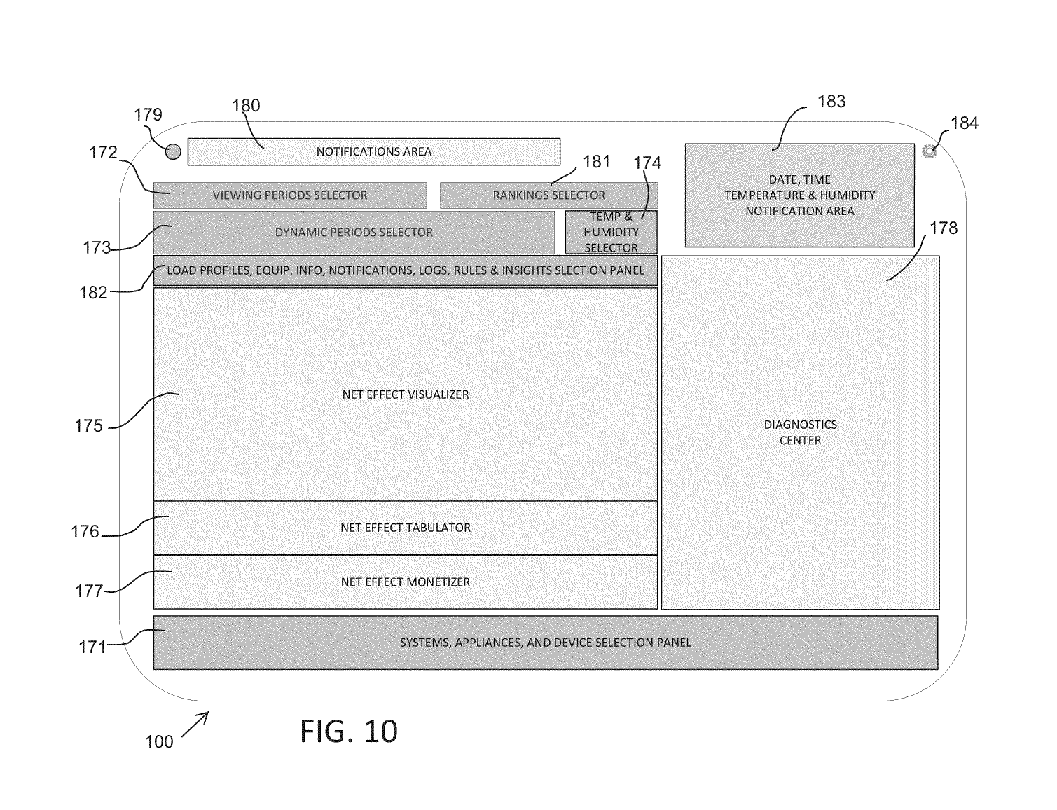

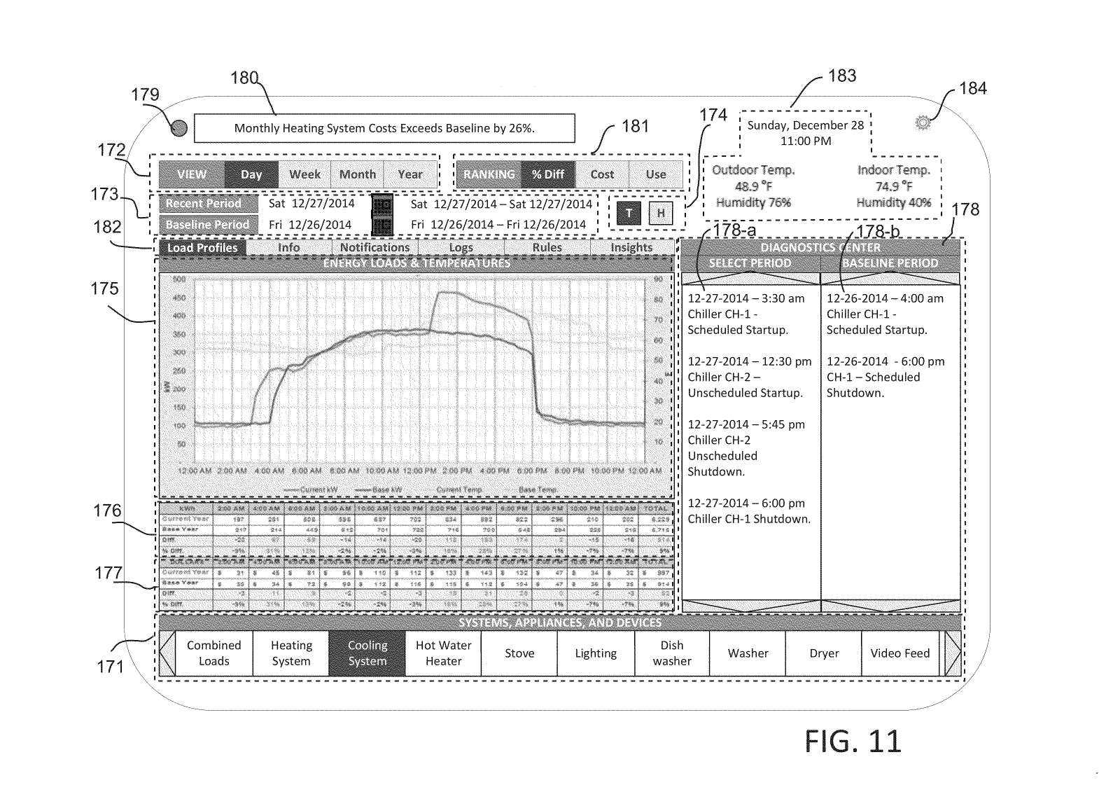

FIG. 10 shows yet another view of the described system functionality, this time in conjunction with an exemplary non-limiting screen or display format CPU 125 under software control uses to indicate pertinent information to users. In this example non-limiting screen display format (may be displayed on any screen or display including a tablet, smartphone, touchscreen, LED or LCD screen, a rester scanned screen or any other display of any desired configuration), CPU 125 provides a systems, appliances and device selection panel 171, a view periods selector 172, a dynamic periods selector 173, a temperature and humidity selector 174, a net effect visualizer 175, a net effect tabulator 176, a net effect valuator/monetizer 177, a warning indicator 179, a notifications area 180, a ranking selector 181, a date/time/temperature and humidity notification area 183, an additional settings indicator 184 and other information including for example a load profiles, equipment information, notifications, logs, rules and insights selection panel 182. As will be understood, such information can be displayed on the same or different screens, scrolled from one screen to another, or provided in different contexts such as by operating indicator lights or other arrangements. However, there are some advantages in the example non-limiting implementation to displaying all such information on the same screen, as can be seen in FIG. 11.

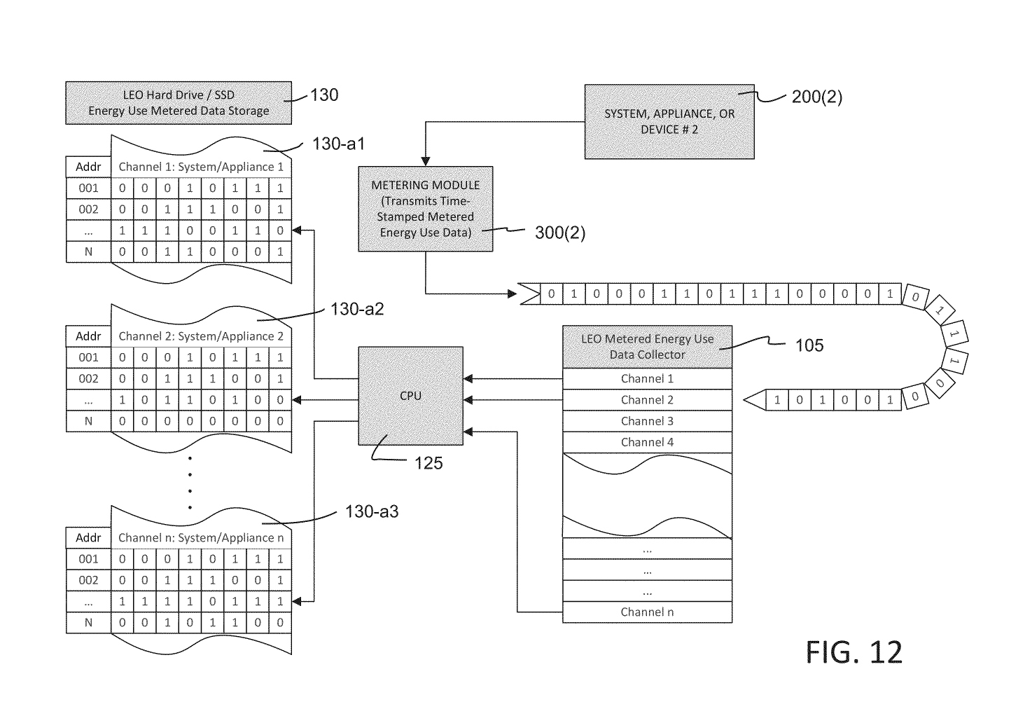

FIGS. 12-22 show example non-limiting data stream processing performed by CPU 125. In the FIG. 12 example shown, three data streams 130-a1, 130-a2, 130-a3 stored on the non-transitory storage device 130 are analyzed and/or maintained by CPU 125. In this particular example, a particular system, appliance and/or device 200(2) monitored by a metering module 300(2) provides a data stream (shown in FIG. 12 as the snake-like sequence of data packets). These data packets may be time stamped by the metering module 300(2). Each packet may thus indicate both (a) a particular monitored value (b) and associated time which the value was acquired or otherwise relates to. Such data stream is imported through a particular channel (in this case channel 2) of the data collector 105. CPU 125 may store this data stream, along with other data streams that are simultaneously being acquired via other metering modules 300 from other systems, appliances and/or devices 200, onto non-transitory storage device 130 in the form of data stream databases 130-a1, 130-a2, . . . 130-aₙ.

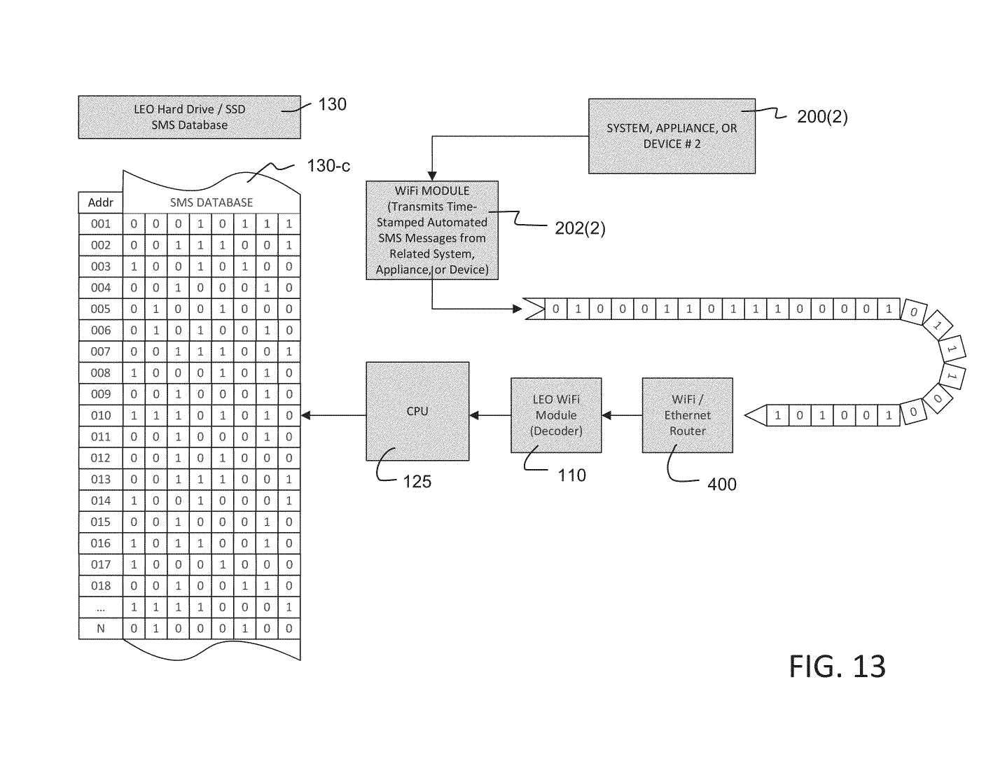

FIG. 13 shows an additional data stream being acquired via the described WiFi transceiver 110. This data stream can be communicated by the originating source such as system, appliance or device 200(2) via an associated WiFi transceiver which may transmit time stamped automated SMS messages or other protocol messages from the system, appliance or device. Such data stream transmitted wirelessly (or wired in other context) may pass through WiFi/Ethernet router 400, be received by the WiFi transceiver 110 and provided to CPU 125 for storage onto the non-transitory storage device 130.

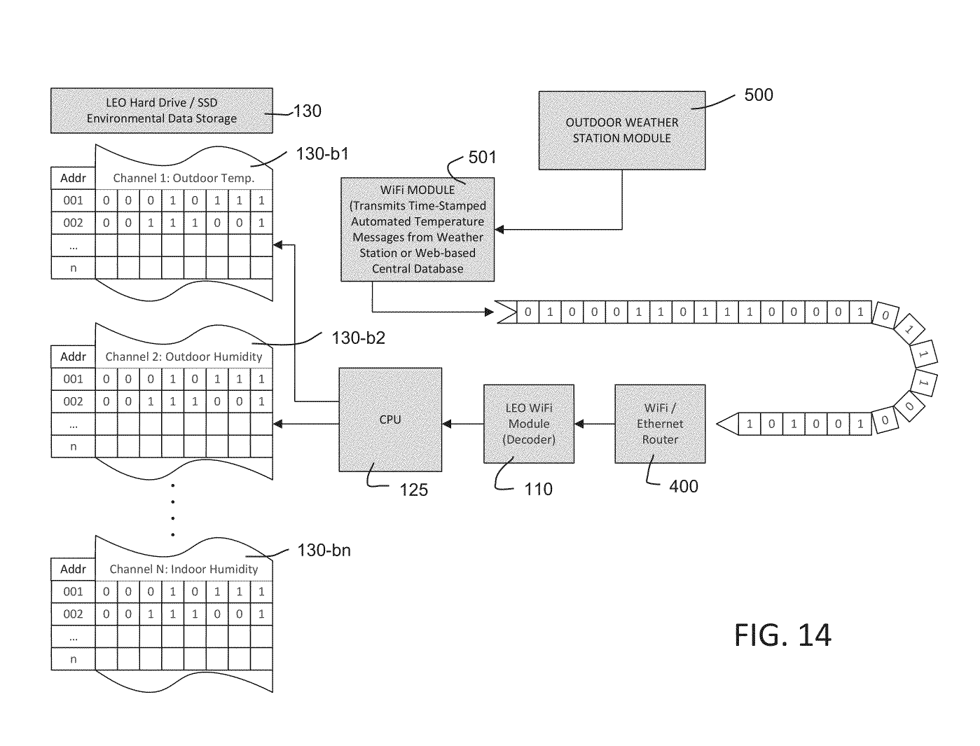

FIG. 14 shows additional data streams indicative of environmental factors being acquired by the system 100. In the FIG. 14 example, an outdoor weather station module 500 may provide an environmental-indicative data stream wirelessly or wired for storage on non-transitory storage device 130. In the example shown, a single data stream provided wirelessly via conventional wireless protocols can be divided by CPU 125 into a priority of data streams such as one data stream indicating outdoor temperature 130-b1, another stored data stream indicating outdoor humidity 130-b2, a further data stream indicating indoor humidity 130-bn, and so on.

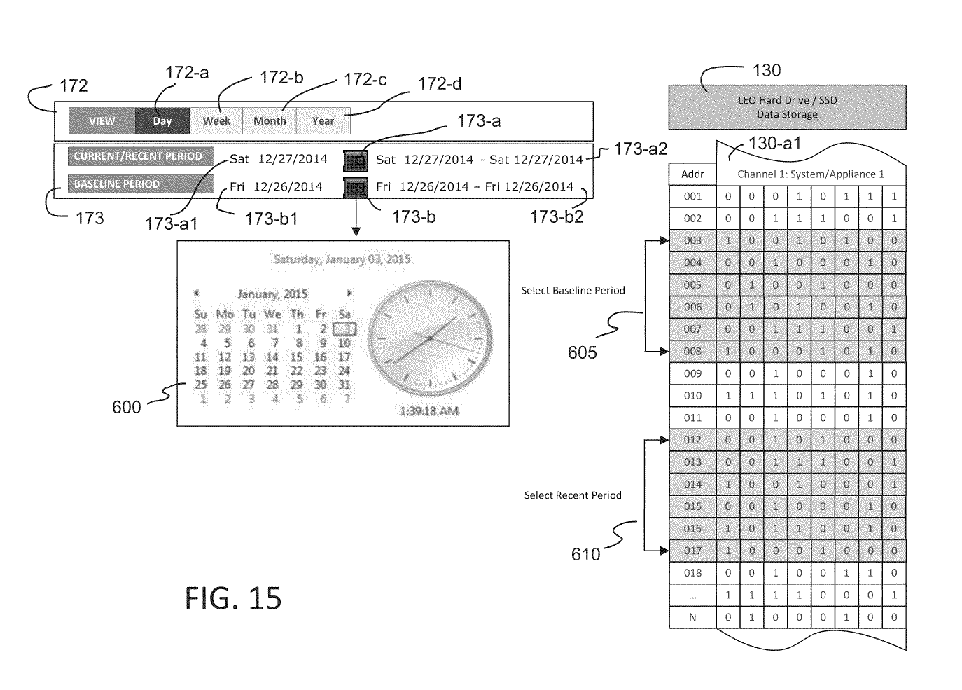

FIG. 15 shows an example non-limiting implementation of a synchronization operation performed by the FIG. 6 synchronizer structures S16, S17 based upon selections performed by the dynamic periods selector S12, S14, S15. In the example shown here, a single data stream 130-a1 stored on the non-transitory storage device 130 is indexed by CPU 125 to determine relevant sub-portions thereof: a selected baseline time period 605, and a selected additional (e.g., more recent) period 610. In one example implementation for example, the selected recent period 610 could be the last day, hour, week or month (or any other desired time period), whereas a selected baseline period 605 may be a prior time period in the same or different stream. For example, in the FIG. 15 example, the current/recent period 610 might be from Saturday Dec. 27, 2014 whereas the baseline period could be the previous day Dec. 26, 2014. A displayed calendar/clock 600 (which may be automatically implemented and used either in accordance with user selection and/or automatic selection) selects the two different time periods 605, 610.

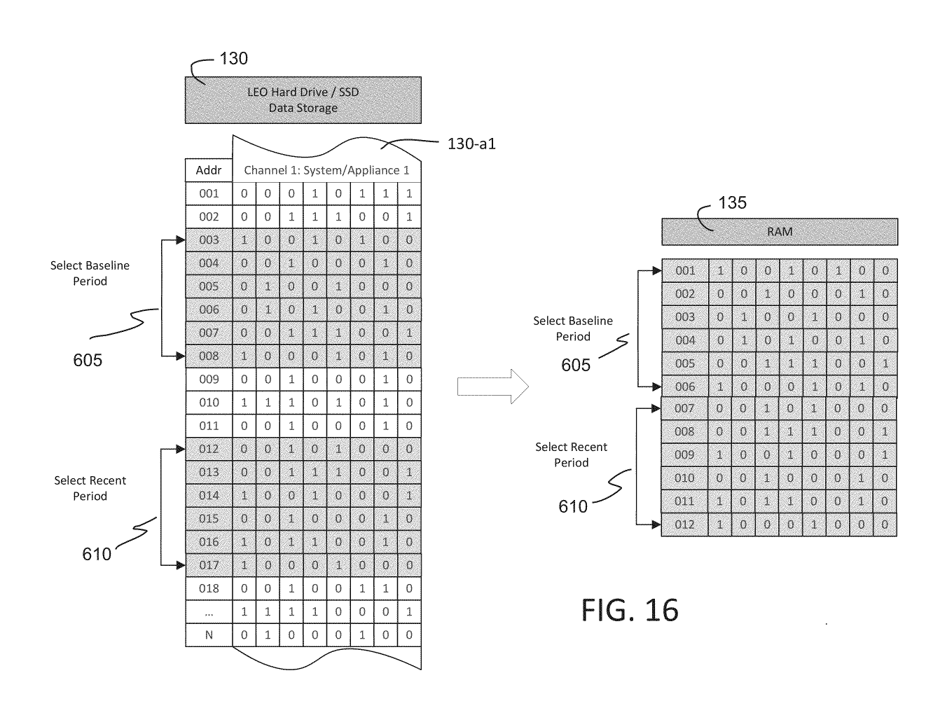

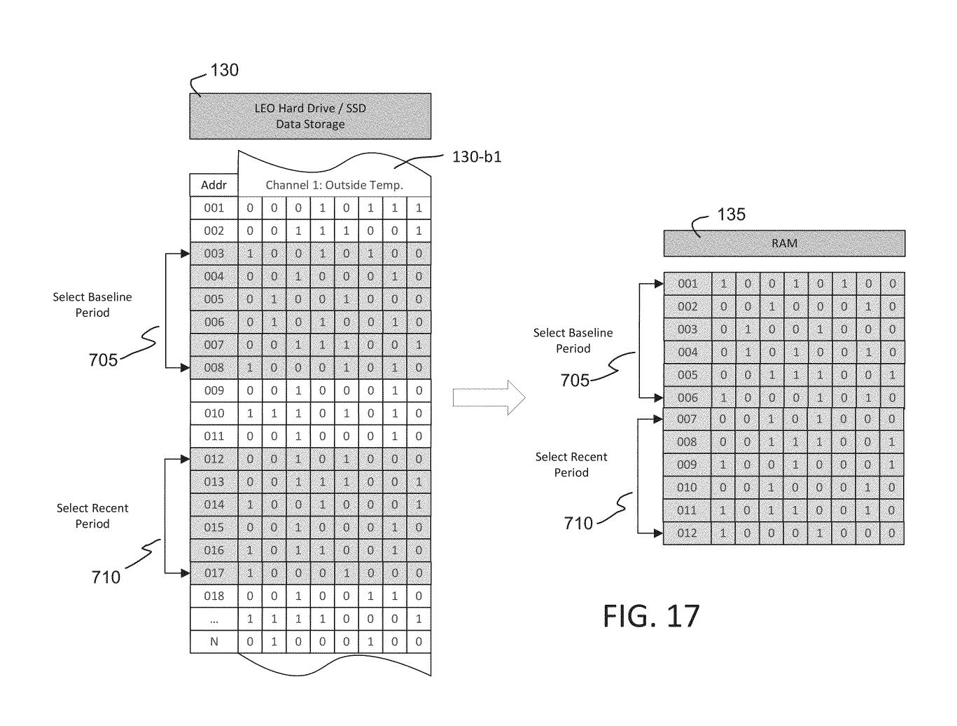

In the FIG. 16 example shown, the CPU 125 may take the selected baseline periods 605, 610 and transfer them from the non-transitory storage device 130 into a random RAM access working memory 135 for analysis. As shown in FIG. 17, the same process shown in FIG. 16 can be applied to additional streams such as weather data.

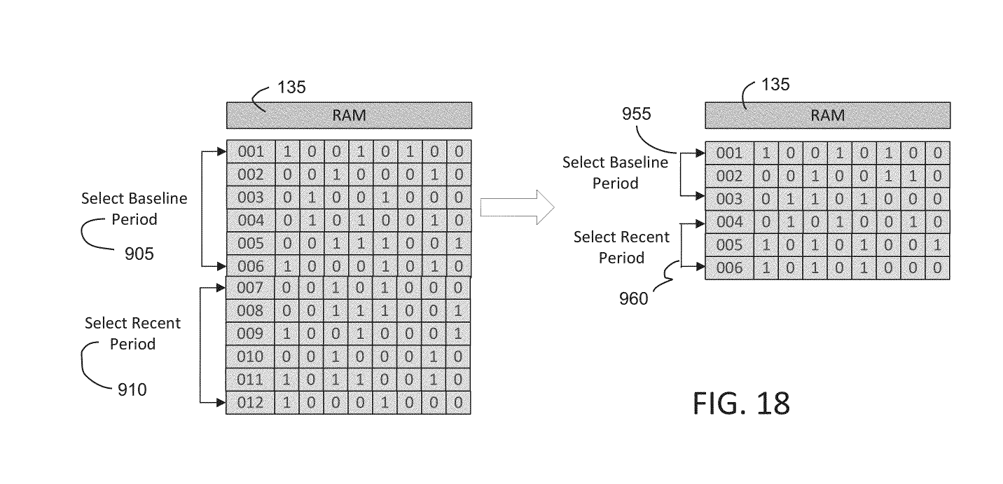

FIG. 18 shows the result of an additional transformation that CPU 125 may perform based on further analysis to aggregate the selected baseline and recent periods into longer (different) time intervals.

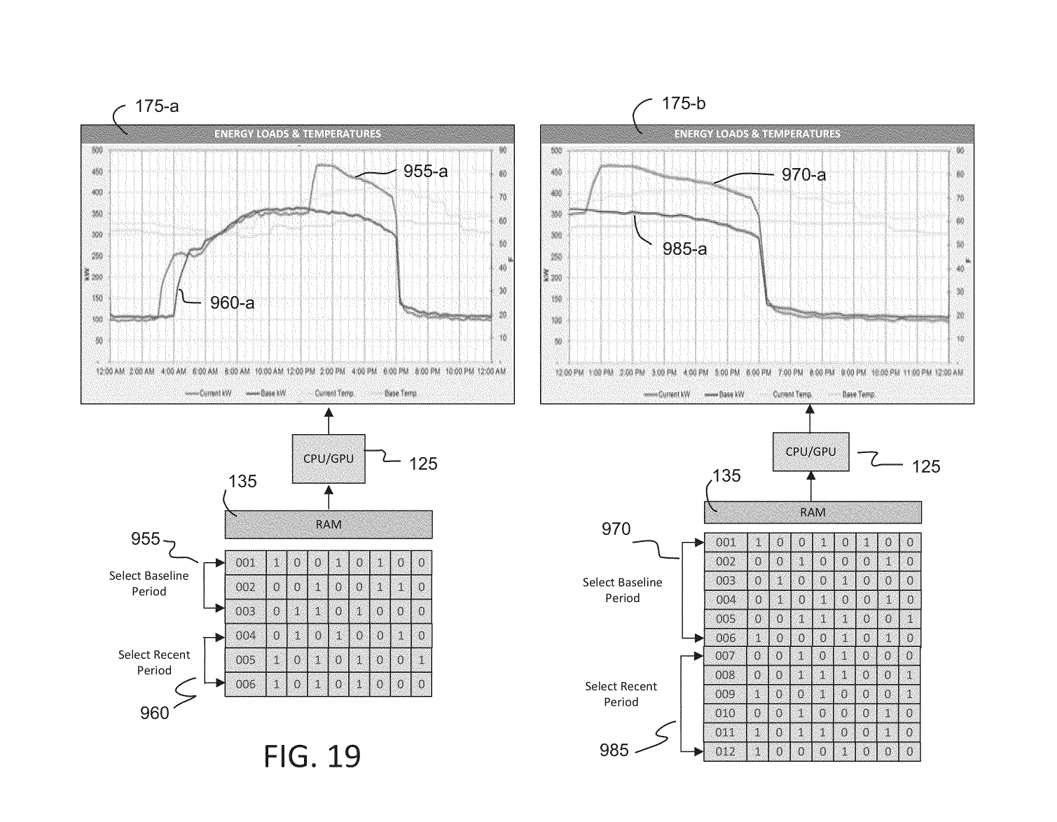

FIGS. 19-22 show example analyses that CPU 125 can perform based upon the selected portions of the two data streams to be compared and/or correlated. In the FIG. 19 example, the selected baseline period 955 may be synchronized with the selected recent period 960 by, for example, lining up individual data points in the streams and/or curves representing the data points. The resulting synchronized streams provide intelligent synchronization between relevant characteristic features of the two or more different selected stream sub-portions, which may be then crossed-correlated and displayed.

As shown in FIG. 19, the time axes of the cross-correlation and/or comparison may be expanded or contracted as desired in order to focus in on particular features or characteristics that differ between the baseline and selected recent periods.

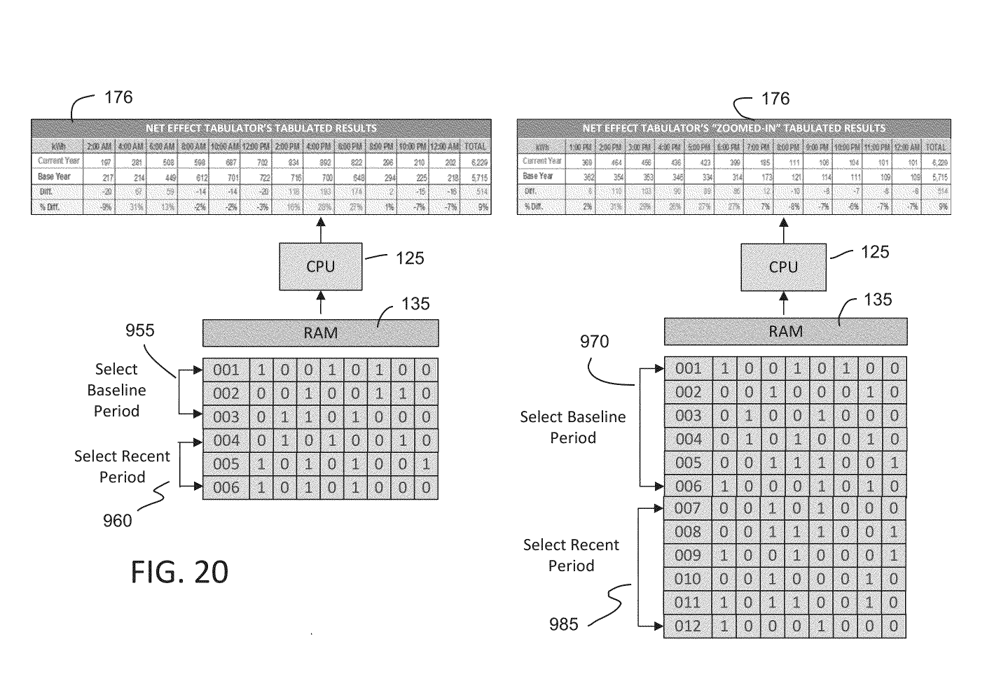

FIG. 20 shows the function of an exemplary net effect tabulator S23 which, rather than providing a graphical visualization, instead compiles a synchronized data set that correlates data points (either actual or interpolated) of the different data streams by time for comparison purposes and further analysis. As shown in FIG. 20, the granularity of the tabulator functionality S23 can be changed so that different precision of the time axes can be used as desired.

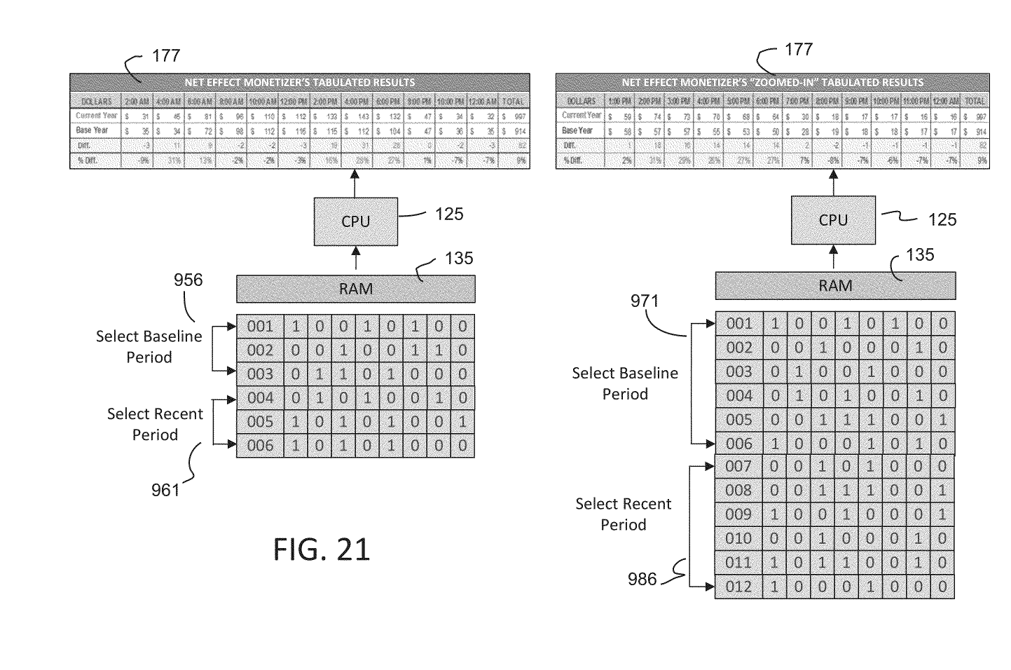

FIG. 21 shows a further CPU 125 analysis performed by a net effect valuator/monetizer S25. In this case, the data resulting from the correlation can be transformed into a value indicator such as conveniently dollars or other monetary units, or any other valuation indicator.

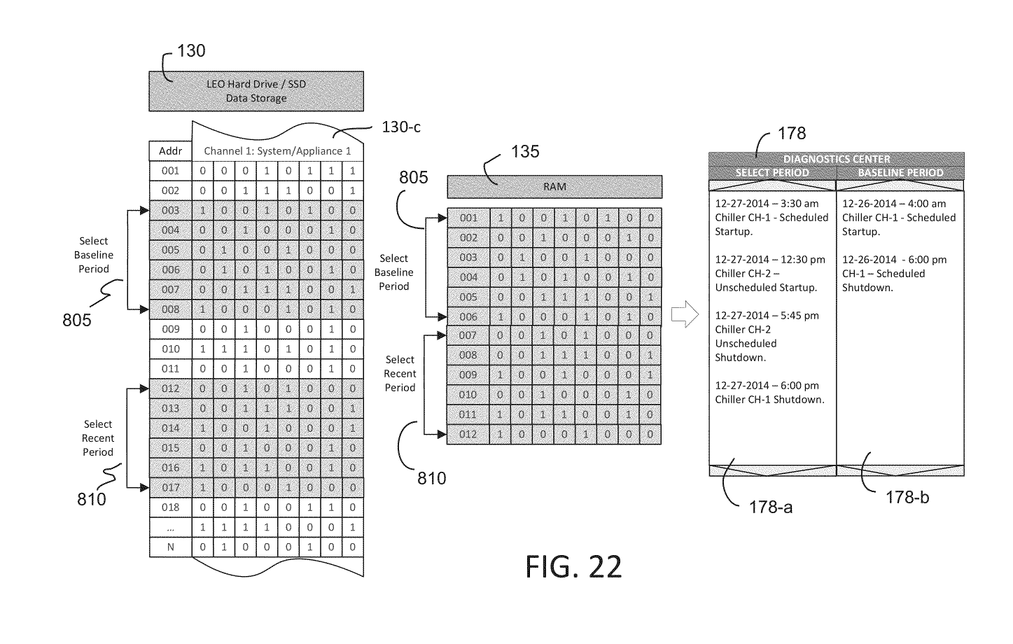

FIG. 22 shows a further CPU 125 analysis using the above-mentioned diagnostic center S18 to generate warning indications or other status indications to indicate exceptions or irregularities in behavior observed via the incoming data streams. For example in FIG. 22, the diagnostics center S18 may correlate an indication of scheduled start up of a particular device with the corresponding time period that the same device was started during the first line time period. By observing comparative status information for the two data stream time periods, it is possible to discern similarities and differences as well exception operations. As described above, comparison is not limited to merely two data streams or data stream sub-portions—any number of data streams can be cross-correlated simultaneously to provide further comparative information.

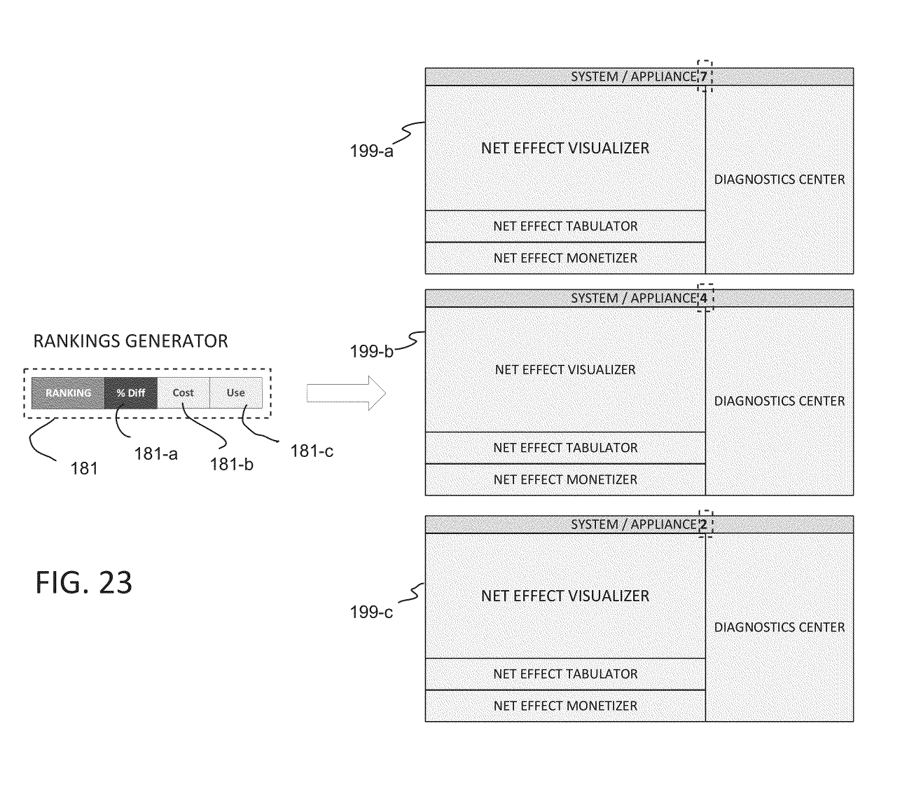

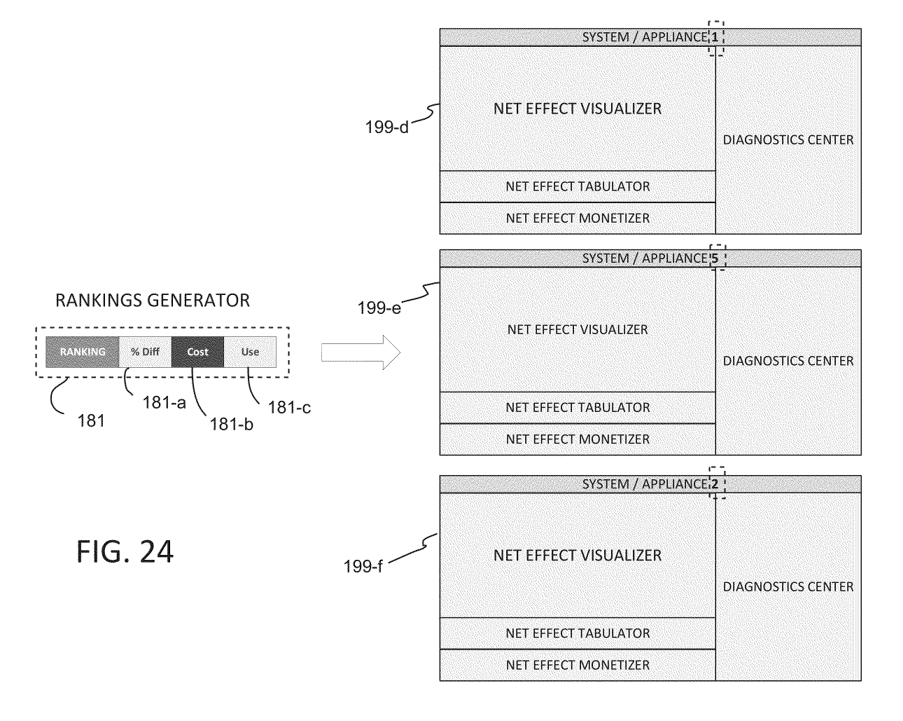

FIG. 23 shows an example operation of the system rankings generator S31 shown in FIG. 6. In this example, the rankings generator S31 may rank results based upon various comparative parameters including for example the percentage difference 181-a, cost 181-b, use 181-c or any other desired parameter. CPU 125 may generate different visualizations simultaneously for each of the rankings so users can visually compare the results as can be seen in FIG. 24, a selection of a different rankings parameter (in this case cost 181-b instead of percentage difference 181-a) may cause a different ordered ranking to be displayed. Scrolling is possible to allow user to scroll up and down in order to see different portions of the ordered ranking.

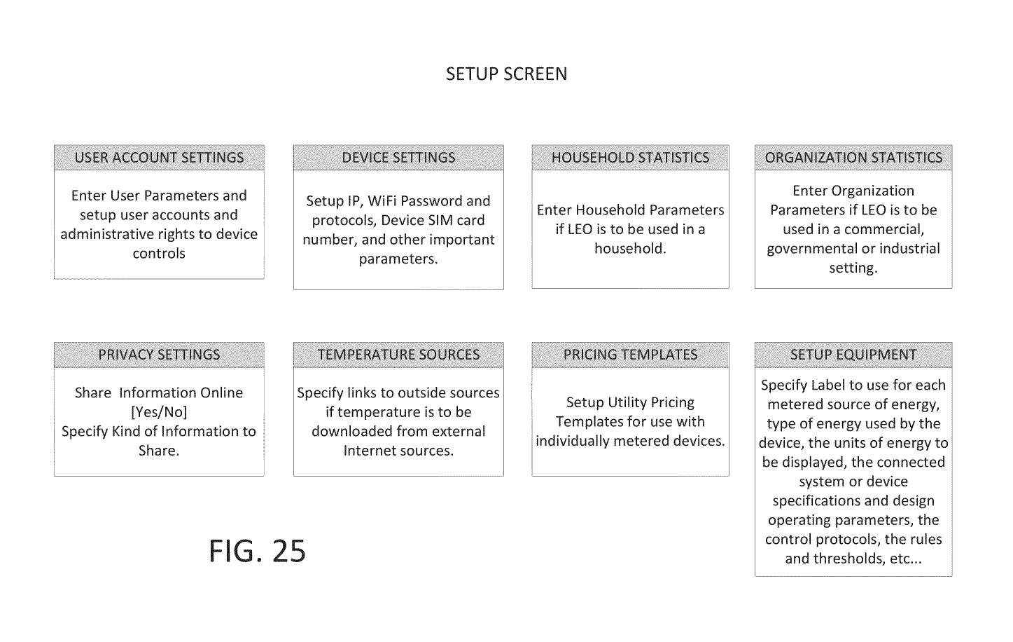

FIG. 25 shows an example set up screen that may be used to promote users to set up the described system 100. Such set up parameters, which CPU 125 acquires via a user interface (locally or remote) and stores in non-transitory storage device 130, may include for example:
user account settings (enter user parameters, set up user accounts and administrative rights to device controls)
device settings (set up IP, WiFi passwords and protocols, device SIM card number and other important parameters)
household statistics (enter household parameters if to be used in a household)
organizational statistics (enter organizational parameters if to be used in a commercial, governmental or industrial setting)
privacy settings (share information online yes/no, specify kind of information to share)
temperature sources (specify links to outside sources if temperature is to be downloaded from external Internet sources)
pricing templates (set up utility pricing templates for use with individually metered devices)
set up equipment (specify label to use for each metered source of energy, type of energy used by the device, the units of energy to be displayed, the connected system or device specifications and design operating parameters, the control protocols, the rules and thresholds, and other information)

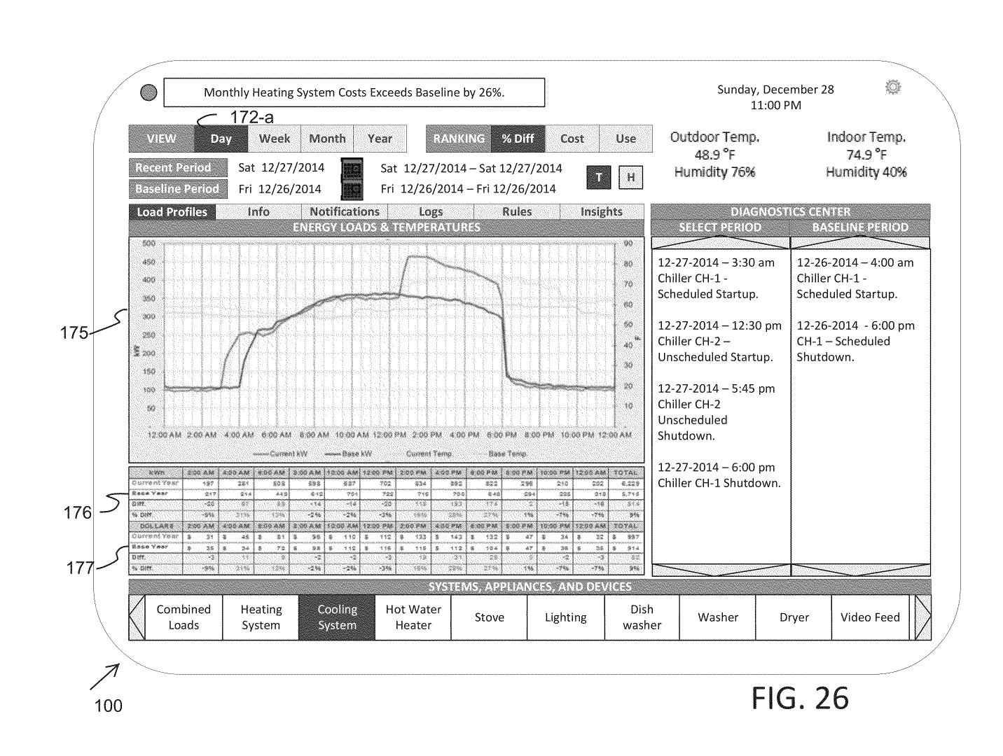

FIGS. 26, 27, 28, 29 and 30 show example non-limiting displays in a particular energy usage context.

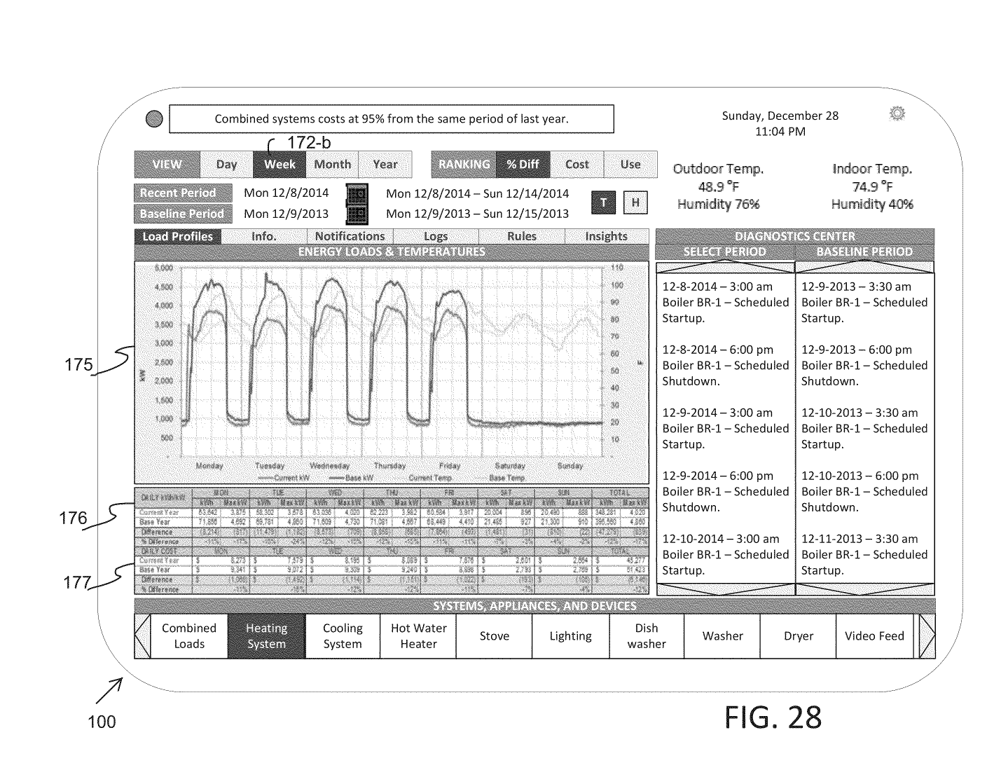

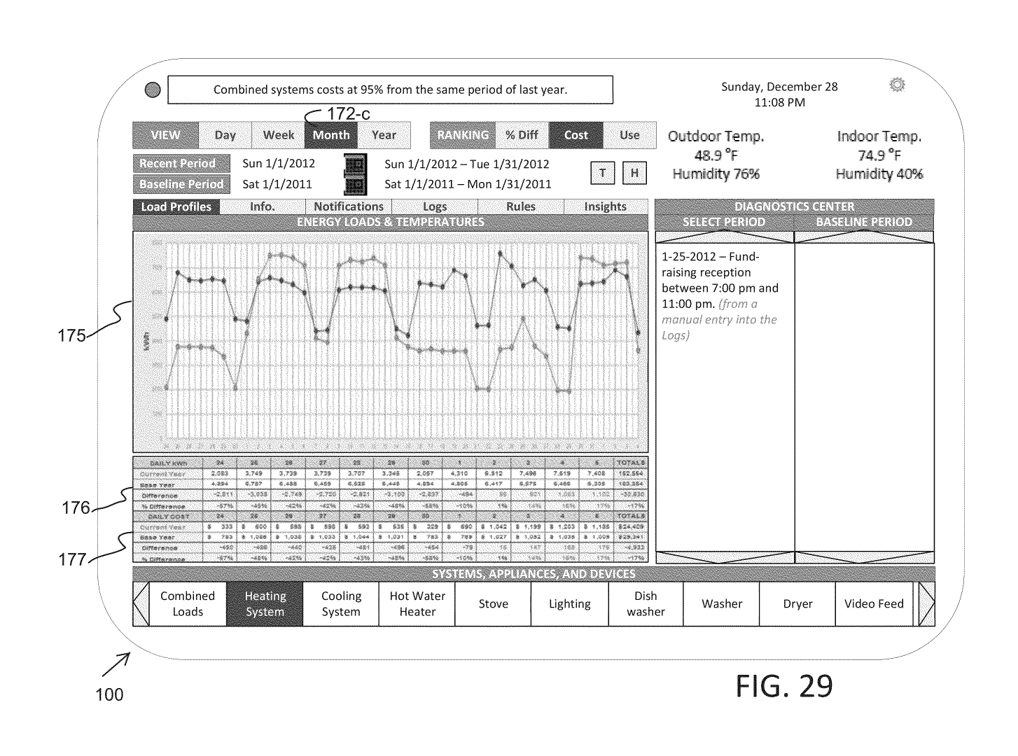

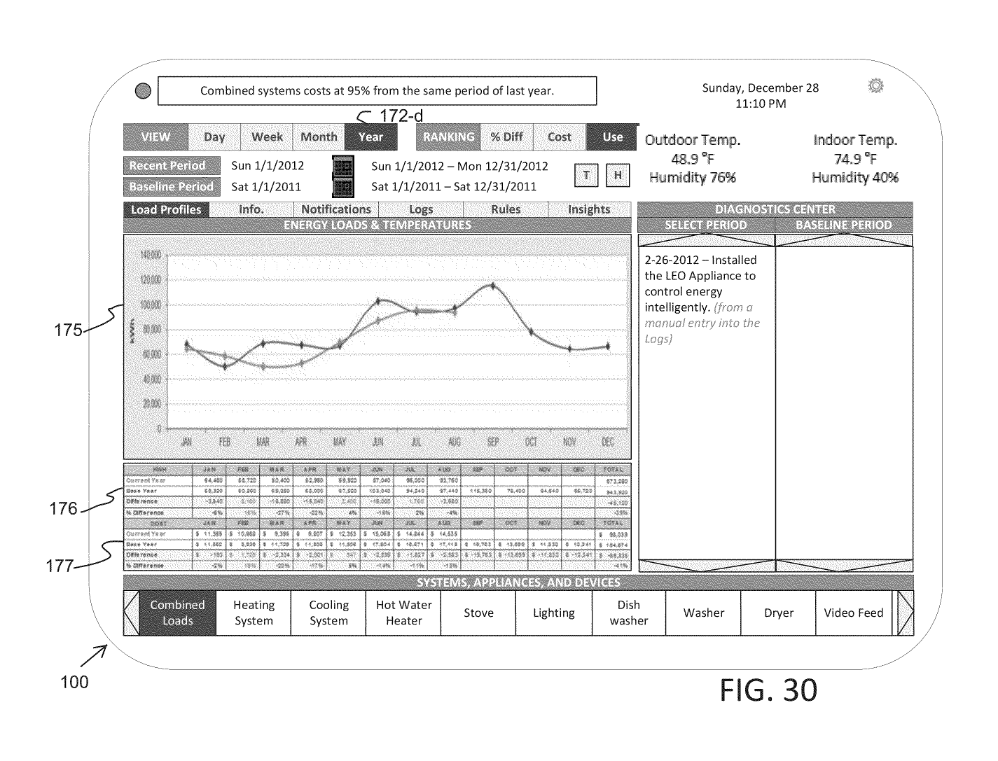

FIGS. 26-30 show example non-limiting screen displays that stream analyzer 100 can generate. Referring to FIG. 26, the viewing period selector 172 specifies the time period duration (day, week, month or year) the dynamic period selector 173 should fetch for synchronization. The user can select different time periods (e.g., week for FIG. 28, month for FIG. 29, year for FIG. 30, and so on). A user is thus able to dynamically measure the Level of Success of a change in a scheduled activity or the Impact of an unscheduled event or activity, or environmental factor, for a specific system or appliance, against multiple—dynamically selected—baselines over time intervals that may encompass a day, a week, a month, and a year and to “zero-in” or “zoom-in” on a specific action or event that may span minutes or hours, in the context of a “Day” view, or an action or event that may span a day or several days in the context of a “Week” view or a “Month” view. Or an action or event that may span months in the context of a “Year” view. The ability to dynamically change a baseline dynamically may be very important to a user because (a) the type of baseline can determine whether a user can measure the Level of Success of a particular energy management action, or determine the presence of “faults” (equipment failures). If the selected baseline is representative of an “average” or “optimum” energy use for a system (e.g., a heating system), then the comparison can detect “faults” or problems if energy use deviates substantially from the desired average or optimum energy use; if on the other hand, the baseline is representative of an “initial state” of known operating parameters, then the comparison will show the “Level of Success” of the action taken with respect to that initial state, and (b) sometimes a user may want to compare the level of success of a particular action to a prior day (incremental change), or to a specific date (differential change). Comparison to a specific date (differential change) may be important, for example, when one wants to compare the level of current energy consumption of a metered system to a specific date when a major change of that system occurred (e.g., to the date that a facility had effected a major change in its lighting system from fluorescent to LED-based lights). On the other hand, an incremental change may be useful when a facility changes the operating hours or the operating parameters of a system from one day to the next (e.g., longer operating hours, lower indoor temperature, etc.).

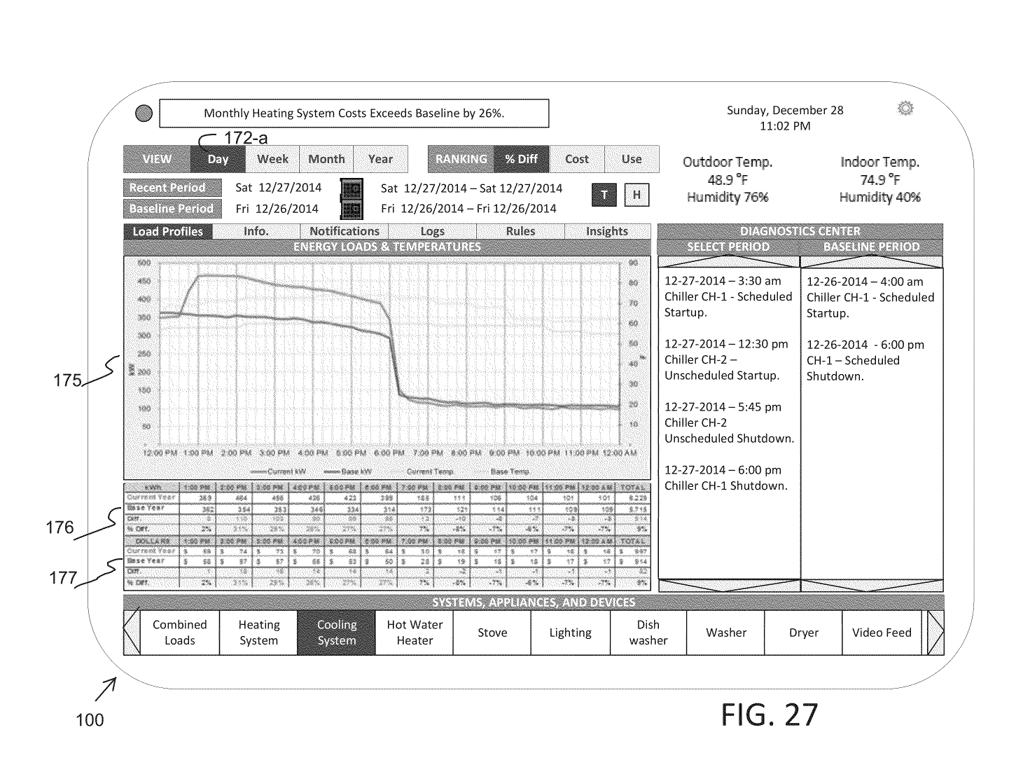

Thus, for example, FIG. 26 shows a visualization over a single day, whereas FIG. 27 shows a visualization over hours within a day. The user has thus been able to zoom in and pinpoint exact amounts of differences. The values displayed on the lower left-hand portions of the displays automatically update with changes in time period selection, giving the user further granularity with respect to particular events the streams evidence. This allows the user to isolate the effects of particular aberrations, faults, disturbances, and other characteristics of interest of the displayed synchronized data streams. The user can dynamically select both start and end of the periods to be visualized as well as time scale and overall time period. All other portions of the displayed formats update automatically so the user is presented with a coherent set of correlated information, calculations, valuations and events for the particular dynamically selected time periods he has selected.

FIGS. 28-30 represent additional visualizations where the user is “zooming out” to longer and longer time periods to view a 7-day profile (FIG. 28), a day in the context of a month (FIG. 29) or a month within the context of a year (FIG. 30). The corresponding valuations show values and total cost per different time periods (e.g., how much money is saved in a day for FIG. 28, how much money is saved or spent (i.e., the differential compared to the baseline) in a month for FIG. 29, and how much money is saved or spent in a year (FIG. 30) along with percentages and other statistics of the differential. The displayed information thus provides the total consumption and cost for the relevant time period, the difference between such consumption and cost compared to baseline, and the percentages of variance of each of those parameters from the baseline. The visualization presented also correlates relative to environmental information such as temperature, and the right-hand side of the display indicates relevant events that occurred during the displayed time period. A consumer could use this correlated coherent information to assess the performance differences for devices that are not usually used continuously such as a dishwasher, a washing machine, a dryer etc. Different time granularities may be relevant to different types of appliances or other loads. Such displayed presentations such as shown in FIG. 28 give a consumer a handle on their exact energy usage, how much the usage costs, and cost or valuation differences based on the effect of different appliance configurations (e.g., changing the hot water heater has saved the consumer $x per month, and lowering the thermostat by 3 degrees Fahrenheit saves $y per day). This allows the consumer to for example make intelligent decisions about appliances to purchase and how to operate them efficiently and cost-effectively.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A stream processor comprising:
a multichannel data collector having a plurality of channel inputs, the multichannel data collector being configured to collect plural data streams from plural corresponding data stream sources;
a memory coupled to the multichannel data collector, the memory being configured to allocate data storage locations for each of the plural collected data streams;
a clock;
a stream analyzer coupled to the memory and the clock,
the stream analyzer comprising:
a dynamic periods selector structured to dynamically select first and second periods represented by at least one of the plural collected data streams,
a synchronizer structured to synchronize stream data associated with the first period with stream data associated with the second period,
an aggregator coupled to the synchronizer, the aggregator being structured to aggregate the synchronized stream data by a selectable aggregation amount,
a net effect analyzer coupled to the aggregator, the net effect analyzer being structured to determine correlation between the aggregated synchronized stream data, and
a valuator coupled to the net effect analyzer, the valuator being structured to isolate the value of at least one individual action or event the correlated streams represent; and
a control arrangement coupled to the stream analyzer, the control arrangement generating and outputting control signals that remotely trigger automated processes based on predetermined rules and thresholds in response to said isolated value.

2. The stream processor of claim 1 wherein the memory comprises a non-volatile memory and a random access memory, wherein the stream analyzer copies collected data streams from the non-volatile memory into the random access memory and uses address indexing to analyze the copied streams.

3. The stream processor of claim 1 wherein the wherein the control arrangement generates SMS control notifications.

4. The stream processor of claim 1 further comprising a wireless network interface.

5. The stream processor of claim 1 wherein the data collector is coupled to plural data stream sources via plural sub-metering modules, wherein each of the data streams provided by the sub-metering modules is time-stamped and/or time-encoded.

6. A system comprising:
at least one storage device storing: (1) energy-consuming equipment operating profiles (metered data), (2) timing of scheduled and unscheduled actions and events, (3) energy pricing templates, (4) control protocols including rules and thresholds, (5) executable program code, (6) equipment specifications and operating parameters, (7) user statistics; and
at least one processor connected to the at least one storage device, the at least one processor executing said stored program code, the stored program code configuring the at least one processor to provide:
a dynamic periods selector that dynamically selects a stream of real-time, recent, or historical energy use data of known operating parameters over time intervals that may encompass a day, week, month, or a year and a baseline period of known operating parameters, from the same stream of data (belonging to the same device, system, or appliance), that may encompass similar time intervals;
an operating profiles synchronizer coupled to the dynamic periods selector that dynamically fetches and synchronizes the energy data over the requested time intervals and sends the data to a coupled energy and weather data aggregator;
an environmental factors synchronizer coupled to the dynamic periods selector that synchronizes the start time of real-time or recent weather data with similar historical weather data as specified by the dynamic periods selector by day, week, month, or year and sends the data to a coupled energy and weather data aggregator;
an energy and weather data aggregator coupled to the operating profiles synchronizer and the environmental factors synchronizer that aggregates the synchronized operating profiles data and environmental factors data in increments ranging from 1 second to 1 hour over the requested time interval (e.g., day, week, month, or year);
a net effect visualizer coupled to the energy and weather data aggregator that visualizes the level of success of scheduled actions and the impact of unscheduled actions, events, and environmental factors by visually superimposing the data synchronized by the operating profiles synchronizer and aggregated by the aggregator in order to give shape, magnitude, and direction to the net effect of a change in operating profile between a selected period and a corresponding baseline “net effect”, the net effect visualizer also overlays corresponding environmental factors when such factors influence a device or system's operating profile;
a net effect tabulator coupled to the net effect visualizer that tabulates the net effect of the change in operating profile by subtracting the baseline operating profile data from the real-time or recent operating profile data over the selected time intervals in the specified time increments and places the resulting table directly under the net effect visualizer graphs in order to visually connect (or correlate) the shape, magnitude and direction of the net effect of changes in energy operations with their corresponding numeric data;
a net effect analyzer coupled to the net effect tabulator that analyzes the net effect of the change in operating profile against threshold limits and defined rules for real-time and historic fault detection and compares with stored information to form a diagnosis, the net effect analyzer also analyzes the net effect of the change in operating profile for real-time initiation of automated processes when certain conditions between real-time and baseline factors are met;
a net effect monetizer coupled to the net effect tabulator that applies pricing templates to numerically assign and tabulate monetary values to the net effect of the change in operating profiles in specific time increments as derived in the net effect tabulator in order to provide a commonly understood standard for measuring, understanding, and predicting the level of success of implemented energy management actions and placing the resulting table also directly under the net effect visualizer graphs in order to visually connect (or correlate) the shape, magnitude and direction of the net effect of changes in operations to their corresponding changes in costs;
a systems rankings generator/prioritizer coupled to the net effect monetizer that ranks and sorts the order of displayed devices or systems from various energy sources by sorting and stacking the visual graphs and associated tables for each device vertically by cost (as a common denominator) in a computing device, in order to prioritize corrective and energy optimization measures/actions; and
a Diagnostics Center structure coupled to the Dynamic Periods Selector structure dynamically fetches and synchronizes automated systems and appliances generated notifications as well as user generated manual log entries over the requested time intervals and places the resulting table next to the Net Effect Visualizer graphs so that one can quickly diagnose with fidelity and precision the Level of Success of the scheduled energy use actions and events during the period of time that is being analyzed as well as the impact of the unscheduled energy use actions and events that occurred during that same period of time.
